(19) United States
(12) Patent Application Publication
(10) Pub. No.: US 2011/0219958 A1
(43) Pub. Date: Sep. 15, 2011

(54) Multi-functional food preparation devices

(76) Inventor: Ross Edward Noble, Austin, TX (US)

(21) Appl. No.: 12/661,073

(22) Filed: Mar. 10, 2010

(51) Int. Cl. A23B 4/044; A47J 37/07

(52) U.S. Cl. 99/473; 126/25 R

(57) ABSTRACT

Cooking devices capable of functioning as a smoker, grill and barbequing unit are provided. A device according to the disclosure includes a first chamber and a second chamber, the second chamber including a food cooking surface disposed substantially at its top portion. The first chamber serves as a source of heat in one embodiment, which may be either heat from a gas burner or heat provided by the burning of carbonaceous materials. In another embodiment the first chamber serves as a duct through which heat and/or smoke is conveyed from combustion of wood and/or charcoal an external fire box that is in fluid communication with the first chamber acting as a duct. By providing adjustable vents about a device according to the disclosure, precise control of heating and high efficiencies are attainable. A specially located safety exhaust port and below-grid exhaust port provide synergistic control over the flow of heat and gases through the devices, in conjunction with the user-set openings of apertures present on the adjustable vents present.

### TECHNICAL FIELD

This invention relates generally to devices useful in food preparation. More particularly it relates to devices useful for smoking and cooking foods including various cuts of meat, and vegetables.

### BACKGROUND OF THE INVENTION

According to prior art methods for making “barbeque” foods, heat (and smoke) from wood and/or charcoal are used as fuel to provide temperatures in the range of between about 190 degrees Fahrenheit and about 235 degrees Fahrenheit present in a generally closed cooking chamber. Known conventional grilling is a high-temperature direct cooking process that utilizes temperatures on the order of about 350-400 degrees Fahrenheit. Owing to each of these separate and distinct processes' temperature requirements, it has heretofore been necessary for a person to emply two separate types of cooking units when desiring to carry out these separate modes of food preparation. In accordance with some embodiments of the presently described invention, a device as provided herein has the functionality of both a wood/charcoal fueled offset cooker and a standard gas grill, in one unit. The teachings of this disclosure provide a single device capable of successfully carrying out the functions of both such devices.

### SUMMARY OF THE INVENTION

In one embodiment is provided a device useful for cooking and smoking foodstuffs comprises, in combination: a framework, about which a structure is provided that comprises a first chamber comprising a top portion and a bottom portion, and which further comprises a first gas burner present substantially at the bottom portion of the first chamber. In this embodiment there is also a second chamber comprising a top portion and a bottom portion, that further comprises at least one gas burner present substantially at the bottom portion of the second chamber. Also present in such embodiment is a food cooking surface support structure present about the second chamber. This embodiment includes a cover having a wall and configured to simultaneously cover and at least substantially separate the top portions of each of the first chamber and the second chamber from the ambient atmosphere when in a closed position. The cover includes a vent having an adjustable aperture disposed through a portion of its wall. A safety exhaust port is provided disposed through a wall present in the first chamber, and a below-grid exhaust port is provided disposed through a wall present in the second chamber.

### BRIEF DESCRIPTION OF THE DRAWINGS

Embodiments of the invention take physical form in various elements present and arranged in cooperative connection or relation, various embodiments of which will be described in detail and illustrated in the accompanying non-limiting drawings which form a part hereof, wherein:

FIG. 1 is a perspective view of a device according to an embodiment of the disclosure;

FIG. 2 is a perspective view of a frame construct useful in providing a device according to an embodiment of the disclosure;

FIG. 3 is a perspective view of a subcombination useful in providing a device according to an embodiment of the disclosure;

FIG. 4 is a perspective view of a combination including the frame construct of FIG. 2 in combination with the subcombination of FIG. 3, together useful in providing a device according to an embodiment of the disclosure;

FIG. 5 is a perspective view of a device according to an embodiment of the disclosure;

FIG. 6 is a perspective view of a device according to an embodiment of the disclosure;

FIG. 7. is an overhead view of a device according to an embodiment of the disclosure;

FIG. 8A is a rear view of a device according to an embodiment of the disclosure;

FIG. 8B is a rear perspective view of a device according to an embodiment of the disclosure;

FIG. 9 is a frontal view of a device according to an embodiment of the disclosure;

FIG. 10 is a frontal cutaway view of a device according to an embodiment of the disclosure;

FIG. 11 is a perspective view of a device according to an embodiment of the disclosure;

FIG. 12 is a right side section view of a device according to an embodiment of the disclosure at the location indicated in FIG. 7;

FIG. 13 is a sectional perspective view of a device according to an embodiment of the disclosure at the location indicated in FIG. 7;

FIG. 14 is a side section perspective view of a device according to an embodiment of the disclosure;

FIG. 15 is a side section perspective view of a device according to an embodiment of the disclosure;

FIG. 16A is a perspective view of a portion of a device according to an embodiment of the disclosure;

FIG. 16B is a perspective view of a portion of a device according to an embodiment of the disclosure;

FIG. 16C is a perspective view of a portion of a device according to an embodiment of the disclosure;

FIG. 17 is an overhead perspective view of a device according to an embodiment of the disclosure;

FIG. 18 is an overhead perspective view of a device according to an embodiment of the disclosure;

FIG. 19 is an overhead perspective view of a component useful in combination with a device according to an embodiment of the disclosure;

FIG. 20 is a cutaway view of a component useful in combination with a device according to an embodiment of the disclosure;

FIG. 21 is a side perspective view of a component useful in combination with a device according to an embodiment of the disclosure;

FIG. 22 is a perspective view of a component useful in combination with a device according to an embodiment of the disclosure;

FIG. 23 shows a side schematic view taken from the right side perspective of a device according to an embodiment of the disclosure;

FIG. 24 shows a schematic view taken from the rear perspective of a device according to an embodiment of the disclosure;

FIG. 25 shows a schematic view taken from the rear perspective of a device according to an embodiment of the disclosure;

FIG. 26 shows a schematic view taken from the rear perspective of a device according to an embodiment of the disclosure;

FIG. 27 shows a schematic view taken from the rear perspective of a device according to an embodiment of the disclosure;

FIG. 28 shows a side schematic view taken from the right side perspective of a device according to an embodiment of the disclosure;

FIG. 29 shows a side schematic view taken from the right side perspective of a device according to an embodiment of the disclosure;

FIG. 30 shows a schematic view taken from the front perspective of a device according to an embodiment of the disclosure;

FIG. 31 shows a schematic view taken from the front perspective of a device according to the prior art;

FIG. 32 shows a schematic view taken from the front perspective of a device according to an embodiment of the disclosure;

FIG. 33 shows a schematic view taken from the front perspective of a device according to the prior art;

FIG. 34 shows a schematic view taken from the front perspective of a device according to the prior art;

FIG. 35 shows a schematic view taken from the front perspective of a device according to an embodiment of the disclosure;

FIG. 36 shows a schematic view taken from the front perspective of a device according to an embodiment of the disclosure;

FIG. 37 shows a schematic view taken from the front perspective of a device according to an embodiment of the disclosure; and

FIG. 38 shows a schematic view taken from the front perspective of a device according to an embodiment of the disclosure.

### DETAILED DESCRIPTION

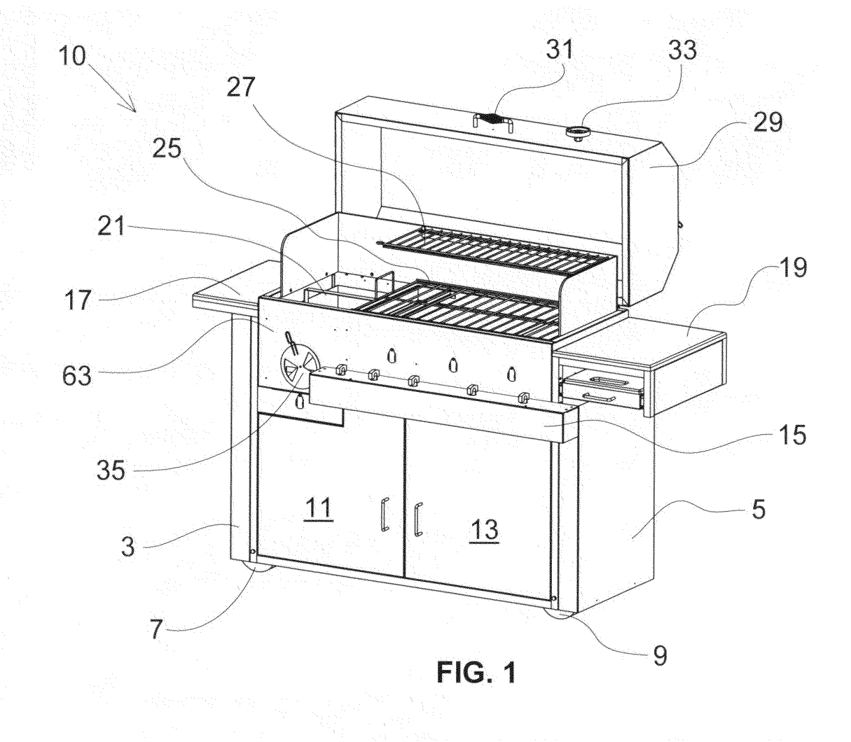

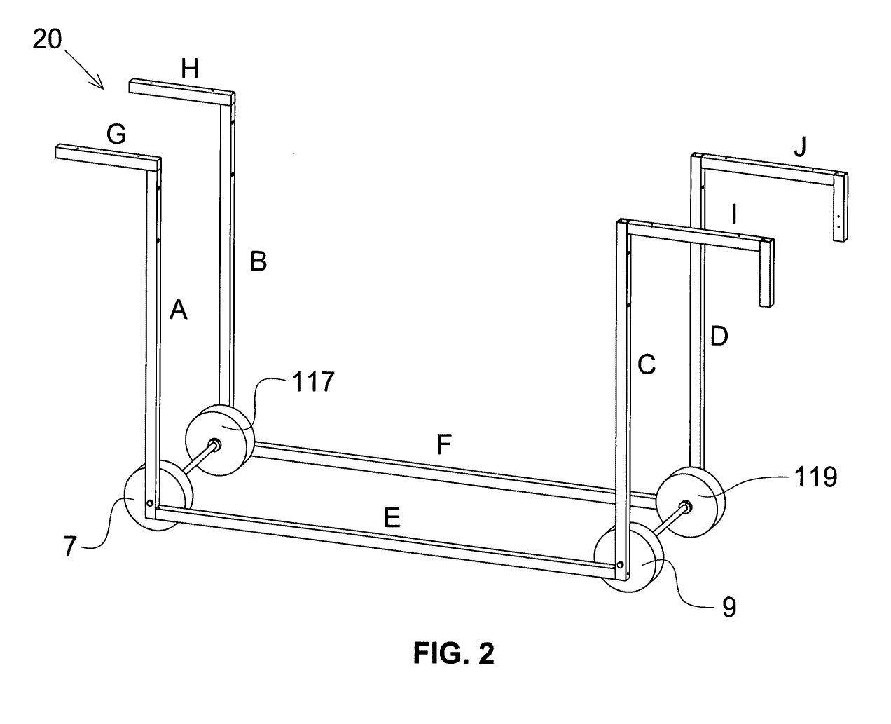

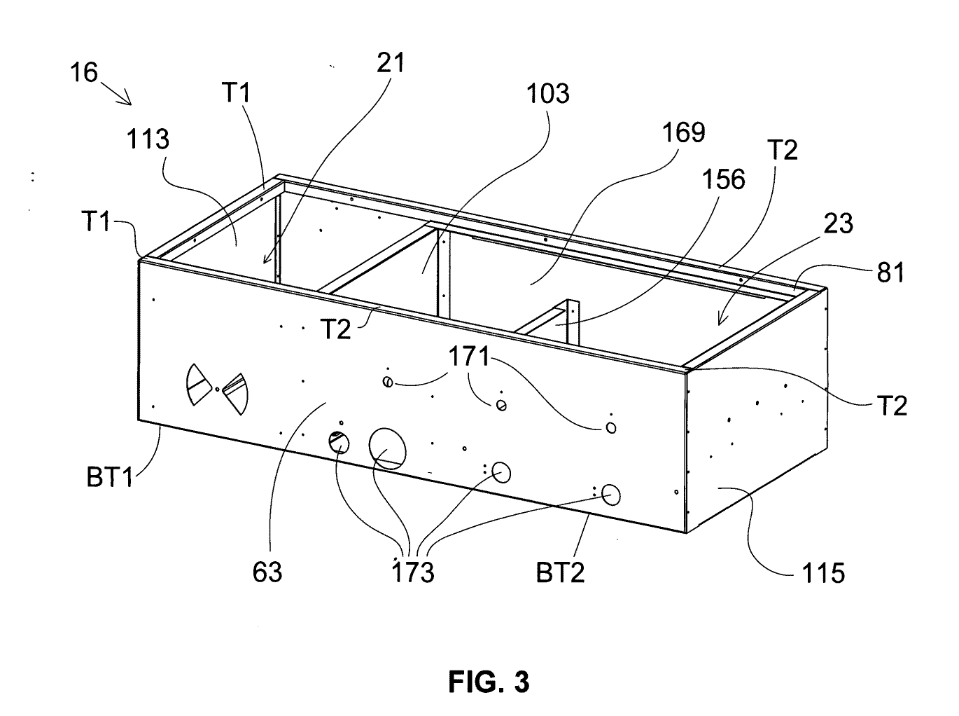

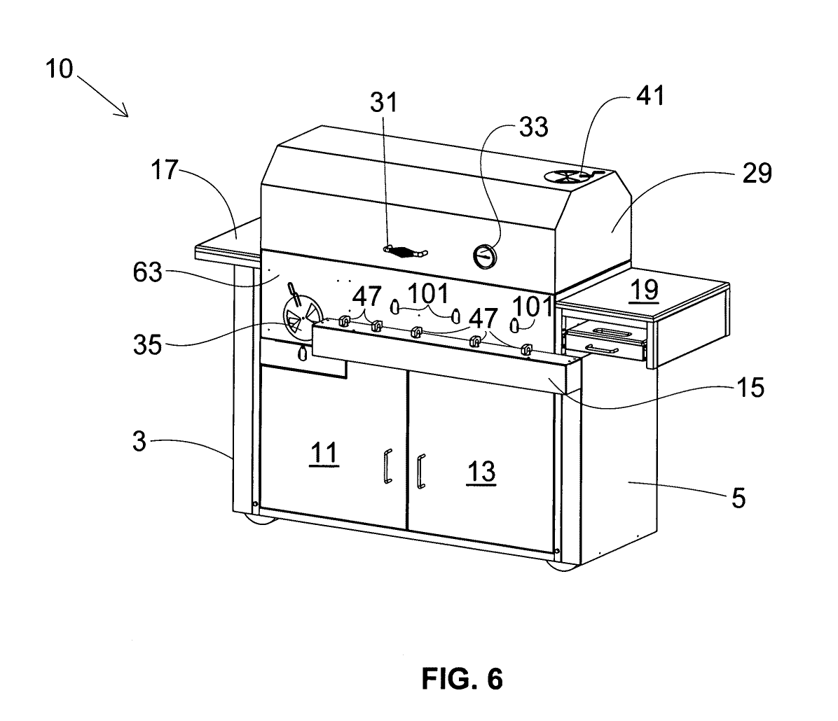

Referring now to the drawings, wherein the showings are provided for the purpose of illustrating the invention only and not for the purpose of limiting the same, FIG. 1 is a perspective view of a device 10 according to an embodiment of the disclosure, showing the respective locations of several of the device's elements. Although not visible in FIG. 1, these elements include a framework about which various elements of device 10 are attached, which framework also provides a volume shaped substantially as a rectangular box having a hollow interior within which various and sundry wares associated with food preparation may be stored or housed, as shown in the embodiment of FIG. 2. A plurality of wheels including wheels 7, 9 that may optionally comprise casters are affixed to the framework, to enable ease in moving such device 10 among various locations as desired. Hingedly attached in common fashion to the front of the framework about which device 10 is built are doors 11, 13 (also shown in FIG. 6) which may be opened and closed independently of one another. There is a right side panel 5 and left side panel 3, which in some embodiments each comprise sheet metal, attached to the framework. Attached to the front portion of the device 10 is a control panel 15, that in one embodiment is configured as a rectangular box having an interior space in which are housed valves and conduits useful for providing selective control of the flow of a feedstock fuel, such as gaseous propane, LP gas, or other suitable cooking fuels, to at least one burner present on device 10. The provision and routing of gas conduits from a gas storage vessel to burners, through control valves is provided herein using conventional known wares. Such known wares include a gas regulator, typically affixed to propane tanks and the like, and conduit pipes, both rigid and flexible, leading from the gas regulator to the inlet of a valve having an inlet and an outlet, the outlet being connected to a gas burner which upon ignition emits a flame. Although various burners are provided in various locations according to the disclosure it should be appreciated that in some embodiments, each of first chamber 21 and second chamber 23 (FIG. 3) comprise at least one gas burner disposed at their bottom portions. There is also a cover 29 hingeably attached to device 10, cover 29 being configured to simultaneously cover the top portions of each of said first chamber 21 and said second chamber 23 when in a closed position as later shown and described, said cover 29 further including a handle 31 and thermometer 33 affixed thereto for providing a person standing beside device 10 an indication of the temperature inside the cover 29 when closed. A front panel 63 in some embodiments comprises a piece of sheet metal attached to the framework about which the device is built, front panel 63 including an adjustable vent port 35 having an opening with an adjustable aperture, as such adjustable aperture vents are generally known in the art of controlling heat and gas flow, adjustable vent port 35 provides a adjustable aperture opening through a wall of first chamber 21. Also present are horizontal first surface 17 and second surface 19, which are present at the right side and left side of the device 10 substantially as shown, in some embodiments affixed to the framework. These surfaces 17, 19 provide a convenient location upon which various items such as utensils, plates and food items may be placed. Shown in FIG. 1 is the location of a first chamber 21, a food cooking surface 25, and an optional cooking surface 27 onto which food items including breads, meats, and vegetables may also be placed, the food cooking surface 25 and optional cooking surface 27 in some embodiments being metallic grills; however, grates or other known structures useful for supporting foods to be heated over a heat source are suitable. The cooperative function of several of the aforesaid elements and the new function of a device according to this disclosure shall be described further below.

Various structures may be employed as a framework upon which various elements of a device 10 as provided herein are constructed, provided the selected structure yields a device having features and functionality as herein taught. In some embodiments the framework comprises a plurality of supports and is in general configured to comprise the shape of a rectangular solid, is typically preferably constructed of metallic components including without limitation bar stock, sheet stock, and tubing stock comprising any selected metals and metallic alloys, including without limitation cast aluminum, the components of the framework being joined by conventional methods of fastening, including without limitation the use of welds, rivets, nuts and bolts, and screws.

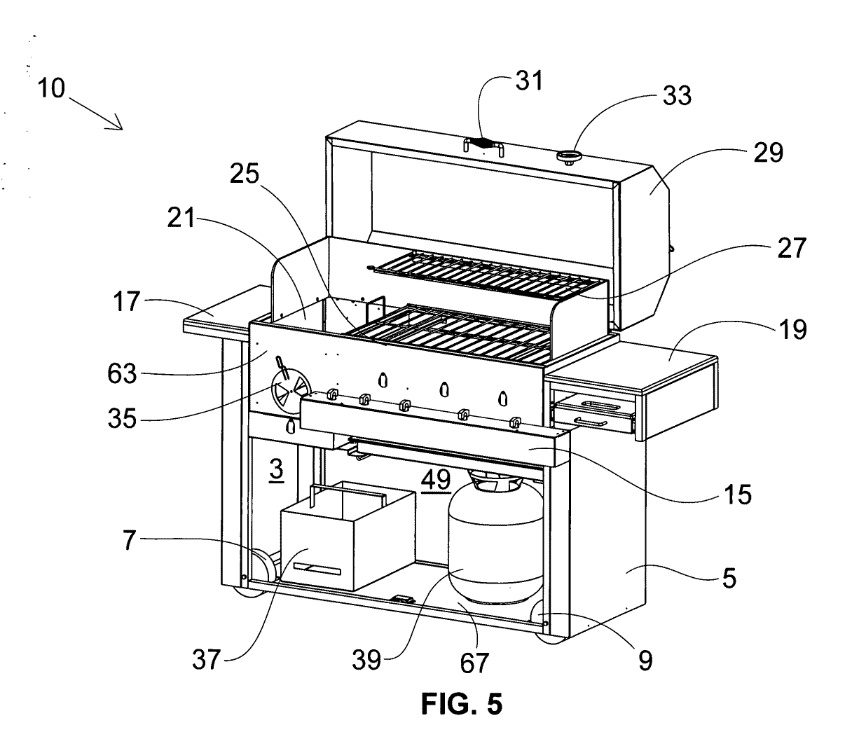

One framework 20 useful in constructing a device 10 according to the disclosure is depicted in FIG. 2. In FIG. 2 framework 20 includes horizontal supports E, F, G, H, I, J and vertical supports A, B, C, D arranged as shown and further comprising axles about which wheels 7, 9, 117, 119 are rotably disposed. In some embodiments front panel 63 of FIG. 1 is attached to vertical supports A, C, right side panel 5 is attached to vertical supports C, D, back panel 169 (FIG. 3) is attached to supports B, D, left side panel 3 is attached to vertical supports A, B, and floor panel 67 is attached to horizontal supports E, F, such attachments being made substantially adjacent to the edges of the various mentioned panels, which in some embodiments are rectangular in shape. Supports B, D in some embodiments supports back panel 169 (the back part of the cooker box), and also rear panel 49 (FIG. 5). In alternate embodiments further supports are present, including a linear horizontal support connectively attached between the points at which supports A, G intersect and C, I, and a horizontal support connectively attached between the points at which supports B, H intersect and D, J. In some embodiments the horizontal and vertical supports shown in FIG. 2 intersect one another at angles of about ninety degrees. A front panel such as 63 is capable of functioning within this disclosure as a support for the framework, in addition to its other functions including providing holes for controllably venting first chamber 21.

FIG. 3 depicts a perspective view of a subcombination 16 useful in providing a device 10 according to some embodiments of the disclosure. In some embodiments, subcombination 16 is structured as a rectangularly-shaped box, comprised of sheet metal and having an open bottom and an open top. In some embodiments subcombination 16 comprises a front panel 63, a back panel 169, a left panel 113, a right panel 115, and a wall 103, each of which elements are attached to one another at the points of their juncture as shown and at right angles to one another. In alternate embodiments, a suitable frame may be constructed and these various elements attached to such frame using conventional fastening means to yield the structure shown in FIG. 3. Such a structure as shown in FIG. 3 defines a region of a first chamber 21, the first chamber 21 being bounded by a portion of front panel 63, left panel 113, a portion of back panel 169, and wall 103. Such structure also defines a region of a second chamber 23, the second chamber 23 being bounded by a portion of front panel 63, wall 103, a portion of back panel 169 and right panel 115. In some embodiments front panel 63 includes pilot holes 171 disposed therethrough which are useful in providing an aperture through which burners in a device 10 as provided herein may be ignited by insertion of a match or other source of flame or spark. Also labeled in FIG. 3 is the top portion T1 of first chamber 21, top portion T2 of second chamber 23, bottom portion BT1 of first chamber 21, and bottom portion BT2 of second chamber 23. In this embodiment, the top portion T1 of first chamber 21 is at least substantially coplanar with the top portion T2 of second chamber 23, with respect to the surface on which a device as provided herein resides. Also shown in FIG. 3 is wall 156 which serves as a partition between burners present on a device according to the disclosure. Holes 173 are present, disposed through front panel 63 which serve as mounting locations for gas flow control valves. Rim 81 is also shown, which provides support for a cooking surface such as a grill or grate, along with the top of wall 103 in various embodiments as shown.

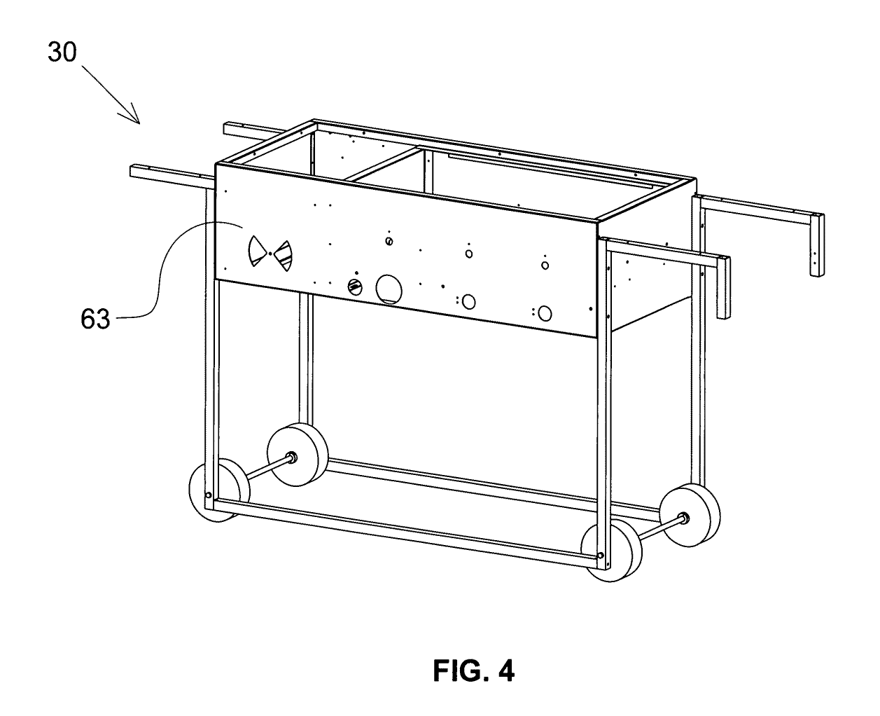

FIG. 4 is a perspective view of a combination 30, which includes framework 20 of FIG. 2 in combination with the subcombination 16 of FIG. 3, together useful in providing a device 10 according to some embodiments of the disclosure. Subcombination 16 is attached to framework 20 by means of conventional fasteners which includes without limitation welds, nuts and bolts, or screws commonly disposed between neighboring portions of framework 20 and subcombination 16 in the arrangement shown.

FIG. 5 shows a perspective view of a device 10 according to an embodiment of the disclosure, as was shown in FIG. 1, with left door 11 and right door 13 removed to reveal a volume inside the framework of device 10, useful for storing various items associated with operation of the device 10, including burn box 37 and fuel vessel 39, which may be a propane tank. These items are in a volume that is partially bounded by the left side panel 3, right side panel 5, rear panel 49, and floor panel 67, each in some embodiments comprising sheet metal of any suitable thickness and selected composition, preferably having any thickness in the range of between about 0.75 millimeters and about eight millimeters and in some embodiments comprising stainless steel. Also shown are the respective locations of the first surface 17, second surface 19, front panel 63, adjustable vent port 35, control panel 15, first chamber 21, food cooking surface 25, optional cooking surface 27, cover 29, handle 31, and thermometer 33.

FIG. 6 is a perspective view of a device 10 according to some embodiments of the disclosure, including features shown and described in reference to the embodiments shown in FIGS. 1 and 5, with cover 29 being in its fully-closed position. Valve control knobs 47 useful for controlling fuel flow to the various burners present on the device are shown present about control panel 15, which control panel 15 is disposed over holes 173 (FIG. 3). Front panel 63 is provided with pilot hole shrouds 101, which shrouds in some embodiments comprise pieces of sheet metal loosely pivotally attached to front panel 63 sufficient to enable the pilot hole shrouds to be readily swung to the left or right to provide access to pilot holes 171 (FIG. 3) disposed through front panel 63, to enable ignition of the burners within, such as by insertion of a lit match or other source of ignition through the pilot holes 171 so shrouded. Also shown are the respective locations of left side panel 3, right side panel 5, left door 11, right door 13, adjustable vent port 35, handle 31, thermometer 33, adjustable vent port 41, first surface 17, and second surface 19. Adjustable vent ports 35 and 41 are in some embodiments comprised of holes present in said front panel 63 and cover 29, respectively, and a piece of metal itself having at least one hole disposed therethrough rotably disposed over said holes present, such as by their being loosely attached by means of a fastener, as such adjustable vents are known in the art.

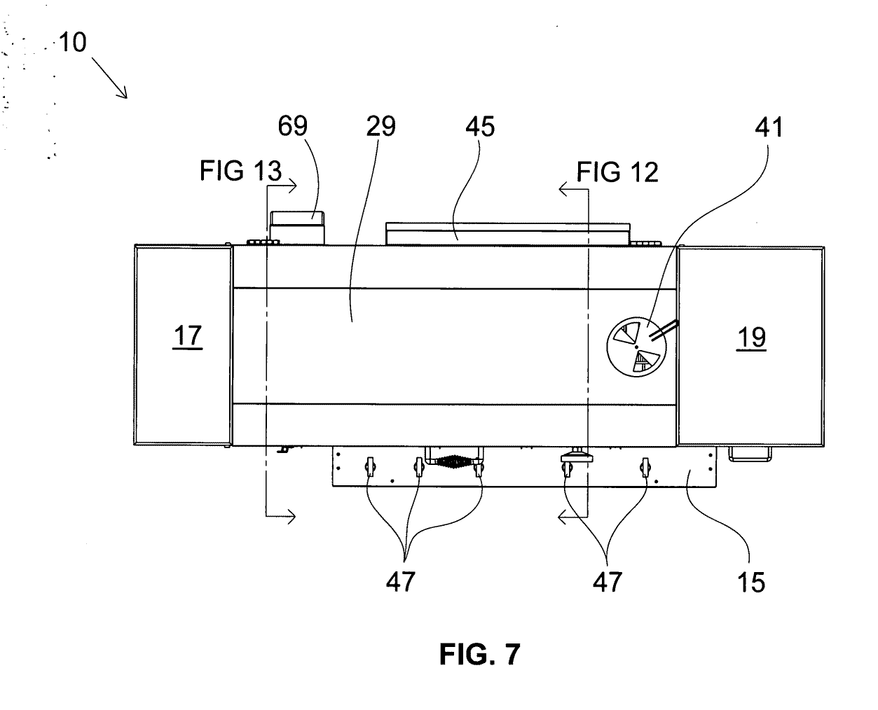

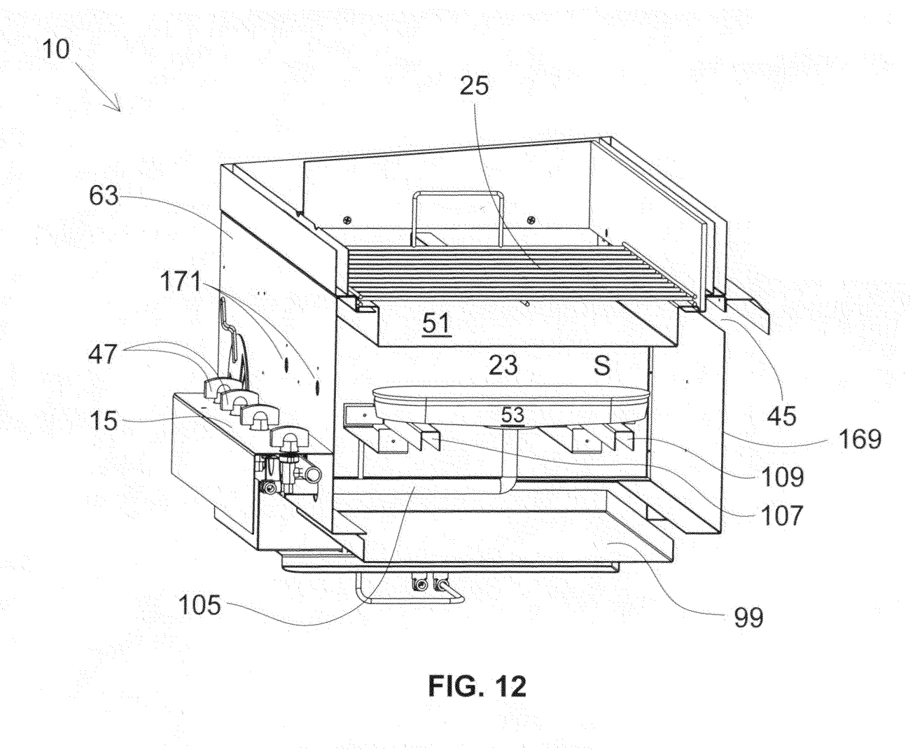

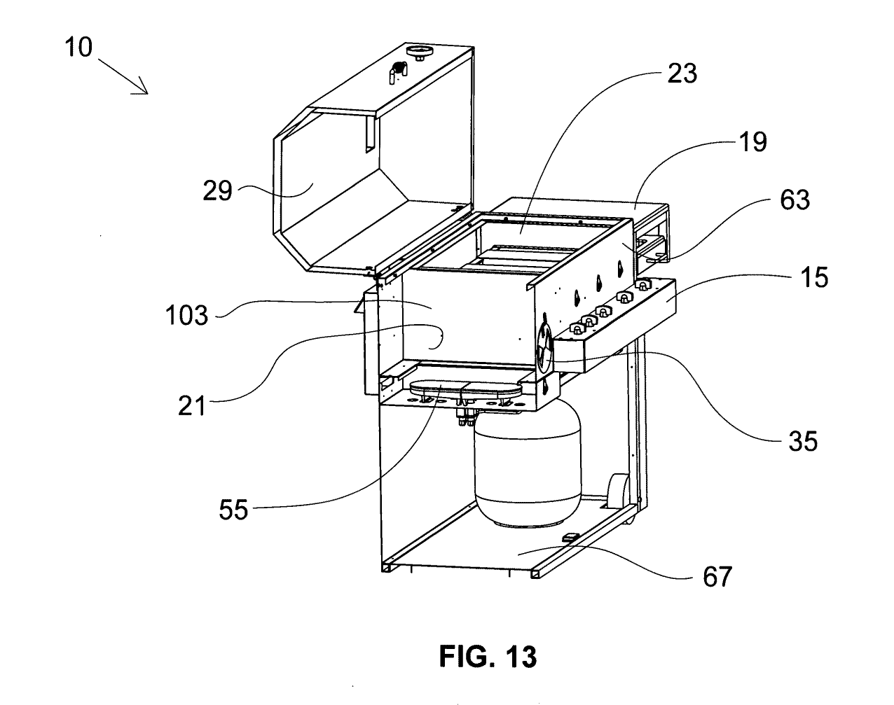

FIG. 7. is an overhead view of a device 10 according to some embodiments of the disclosure, showing the respective locations of the first surface 17, second surface 19, cover 29 in its closed position, control panel 15, valve control knobs 47, adjustable vent port 41, safety exhaust duct 69, and the location of below-grid exhaust port 45. Also shown are the locations of the sectional views later provided in FIGS. 12, 13.

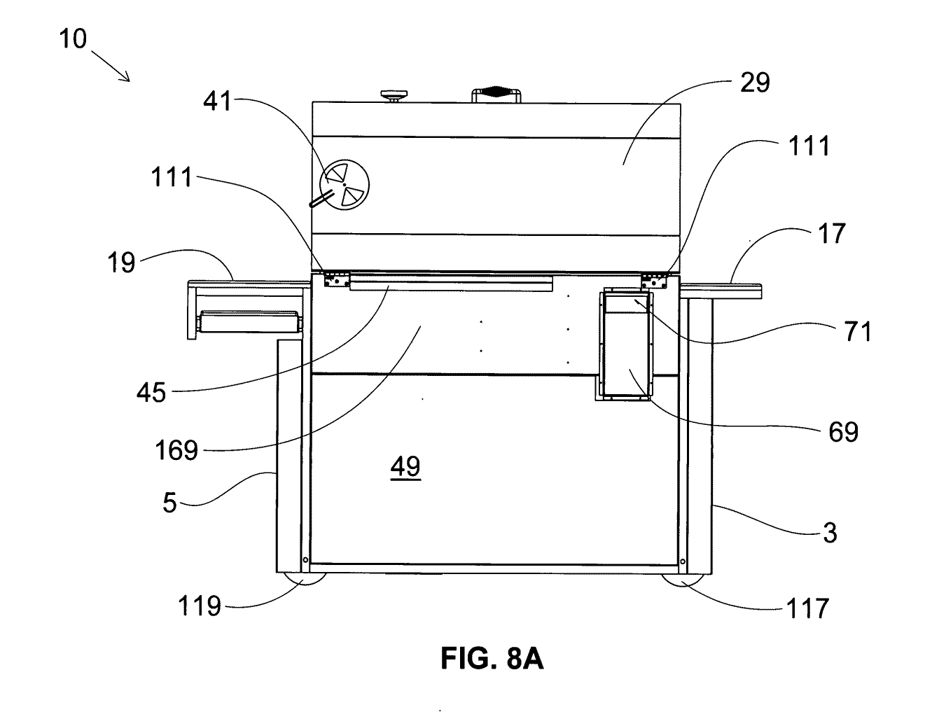

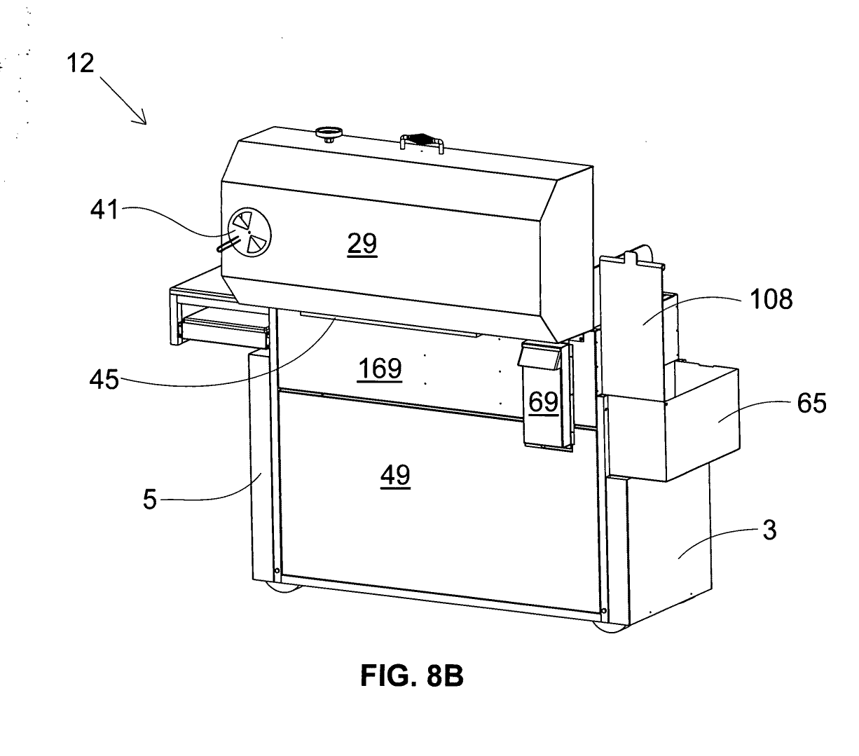

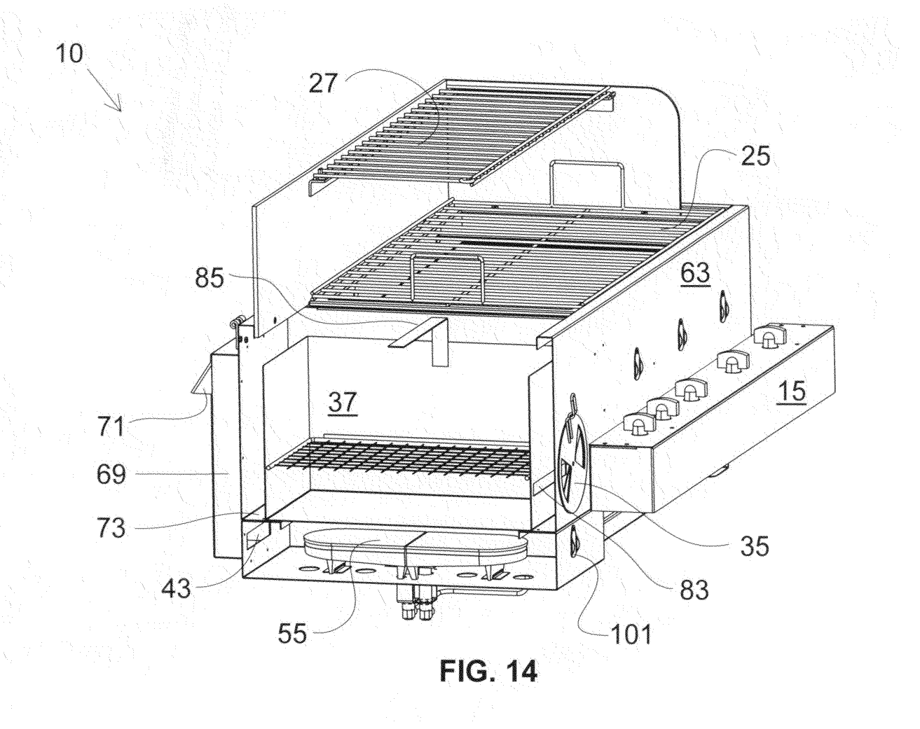

FIG. 8A shows a rear view of a device 10 according to some embodiments of the disclosure, showing the respective locations of cover 29 in a fully-opened position, adjustable vent port 41, first surface 17, second surface 19, rear panel 49, left side panel 3, right side panel 5, wheels 117, 119, below-grid exhaust port 45 and safety exhaust duct 69. In some embodiments, optional safety exhaust duct 69 is a duct that functions as a conduit having a first open end and a second open end, the first open end of which is in fluid communication with (provides a path for air and combustion product gases) a safety exhaust port 43 (FIG. 14), the second open end of which duct is in fluid communication with the ambient atmosphere at safety exhaust outlet 71. In some embodiments, safety exhaust duct 69 is omitted and safety exhaust port 43 (FIG. 14) is directly open to the atmosphere. Cover 29 is attached to the remainder of device 10 by means of hinges 111. Thus, in some embodiments the ambient atmosphere surrounding device 10 is in fluid communication with the interior of first chamber 21 via safety exhaust port 43, and the ambient atmosphere surrounding device 10 is in fluid communication with the interior of the second chamber 23 via the below-grid exhaust port 45, which below-grid exhaust port 45 is a rectangularly-shaped opening or slot present on and disposed through back panel 169.

FIG. 8B shows a rear perspective view of a device 12 according to some embodiments of the disclosure, showing the respective locations of back panel 169, rear panel 49, safety exhaust duct 69, left side panel 3, right side panel 5, below-grid exhaust port 45, cover 29, adjustable vent port 41, firebox 65 having cover 108 hingedly attached thereto, shown in an open position.

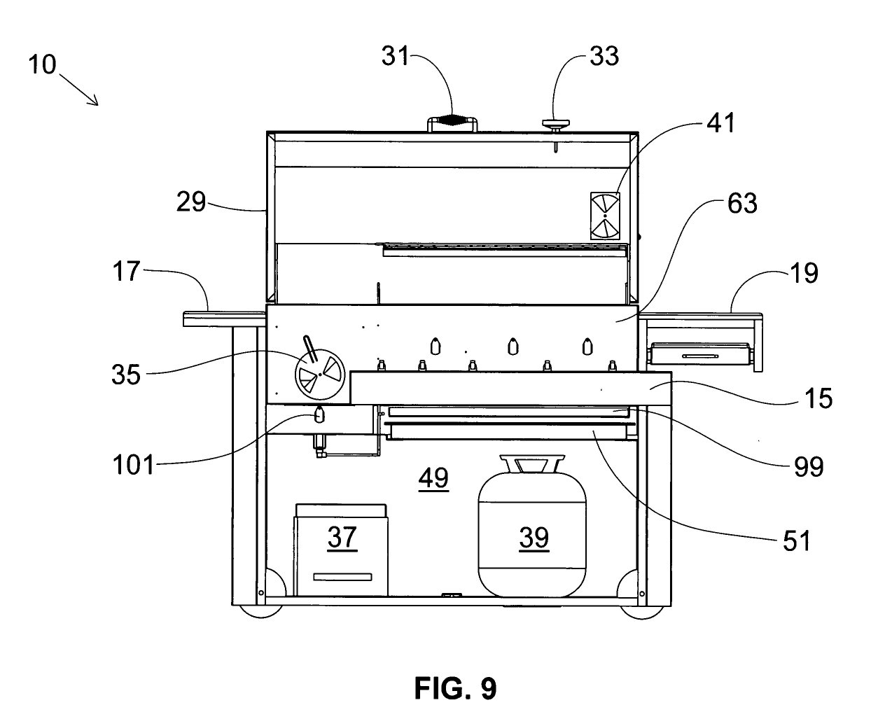

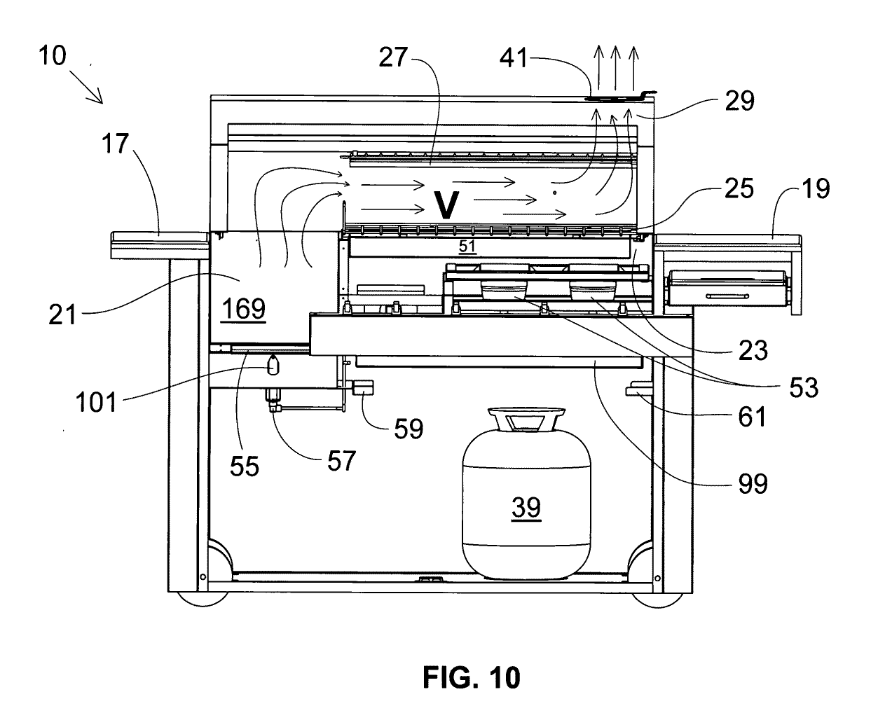

FIG. 9 is a frontal view of a device 10 according to some embodiments of the disclosure, having its cover 29 in a fully-opened position and in which doors 11, 13 are omitted for clarity. In this FIG. 9 are shown the respective locations of front panel 63, adjustable vent port 35, control panel 15, first surface 17, second surface 19, adjustable vent port 41, handle 31, thermometer 33. Also shown in FIG. 9 is drip pan 99 disposed beneath second chamber 23 (FIGS. 10, 12), the function of which drip pan 99 is to capture and collect drippings comprising fats, oils or other matter generated during cooking of meats and the like cooked on cooking surface 25 (FIG. 1). Partition pan 51 is shown in FIG. 9 in its stowed position, for convenience when it is not desired for it to be present in a functional position, stowed beneath food cooking surface 25 and second chamber 23. Burn box 37 and fuel vessel 39 are also shown in FIG. 9 in their stowage locations.

FIG. 10 is a frontal cutaway view of a device 10 according to some embodiments of the disclosure, showing the respective locations and arrangement of various elements and features, including partition pan 51 having a lip and disposed in a functional position with its lip resting on rim 81 (FIG. 3) substantially at the top of second chamber 23 and immediately beneath food cooking surface 25. When partition pan 51 is selected by a user of device 10 to be disposed in the position shown in FIG. 10, partition pan 51 effectively acts as a barrier to seal off or otherwise separate the volume of second chamber 23 disposed beneath partition pan 51 from the volume V above food cooking surface 25. Stated another way, in some embodiments when partition pan 51 is present in the location as shown in FIG. 10, it functions as a roof for second chamber 23, the remaining walls of second chamber 23 comprising portions of rear panel 169 (FIG. 3), right panel 115 (FIG. 3), front panel 63 (FIG. 3) and wall 103 (FIG. 3). Such an arrangement provides the functionality that when cover 29 is in a closed position as shown in FIG. 10, heat that is generated within, substantially within, or provided to first chamber 21 is caused to flow from the region above first chamber 21, as shown by the arrowed lines, and flow over food cooking surface 25, and out of device 10 through adjustable vent port 41 when adjustable vent port 41 is in an open position. With respect to a cut or meat or other food item that is desired to be heated and/or smoked and that is placed atop food cooking surface 25 in a device 10 provided according to the disclosure configured as in FIG. 10, such a flow of heat in the direction shown by the arrowed lines in FIG. 10 enables “top-down” cooking, that is—cooking of a cut of meat or other food wherein the heat is applied predominantly from above and around the cut of meat or other food, but not substantially from below it. This arrangement causes meats and other foods so treated to be basted from the top-down during cooking, i.e., juices within the food generated by the action of heat on the uppermost portions of the food are pulled by gravity through the food item being cooked, as opposed to grilling in which strong heat is applied at the bottom of the food only permitting minimal self-basting. Optional cooking surface 27, which as mentioned may also comprise a grill just as food cooking surface 25, is also in the path of heat indicated by the arrowed lines. In some embodiments, heat and smoke are generated within first chamber 21, by the selected presence of burn box 37 containing a fuel source such as charcoal, wood or other carbonaceous combustibles, or heat provided by gas-fired burner 55 also shown in FIGS. 13, 14 in more detail. In some embodiments, burner 55 may comprise a plurality of burners, as shown in FIG. 14 wherein two separate burners are present.

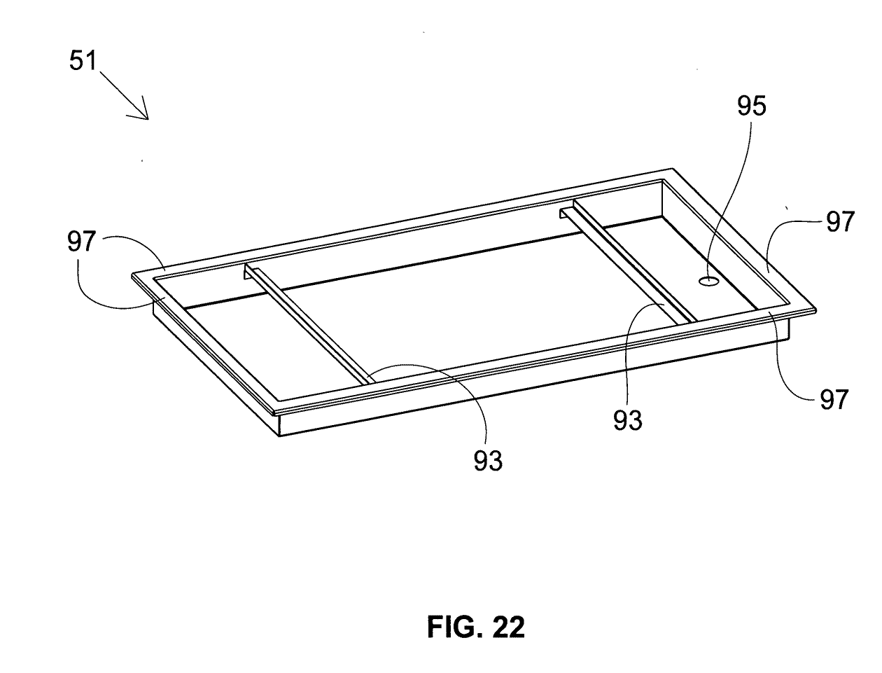

Also shown in FIG. 10 are tangs 59, 61 useful for holding partition pan 51 in a stowed position when not being used as a roof over second chamber 23, onto which tangs the side portions of perimeter lip 97 (FIG. 22) of partition pan 51 engage in a slidable fashion, enabling partition pan 51 to be slid in and out of device 10, like a drawer. Also shown in FIG. 10 are the locations of burners 53, and burner 55 present at the bottom of first chamber 21, fuel conduit 57 for providing fuel to burner 55, fuel vessel 39, first surface 17 and second surface 19.

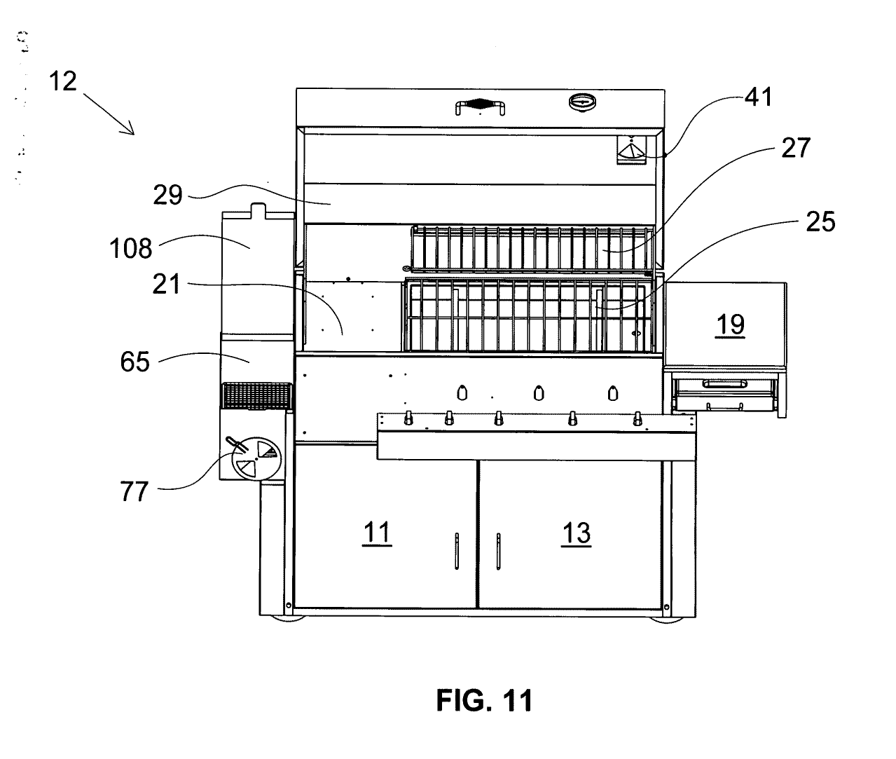

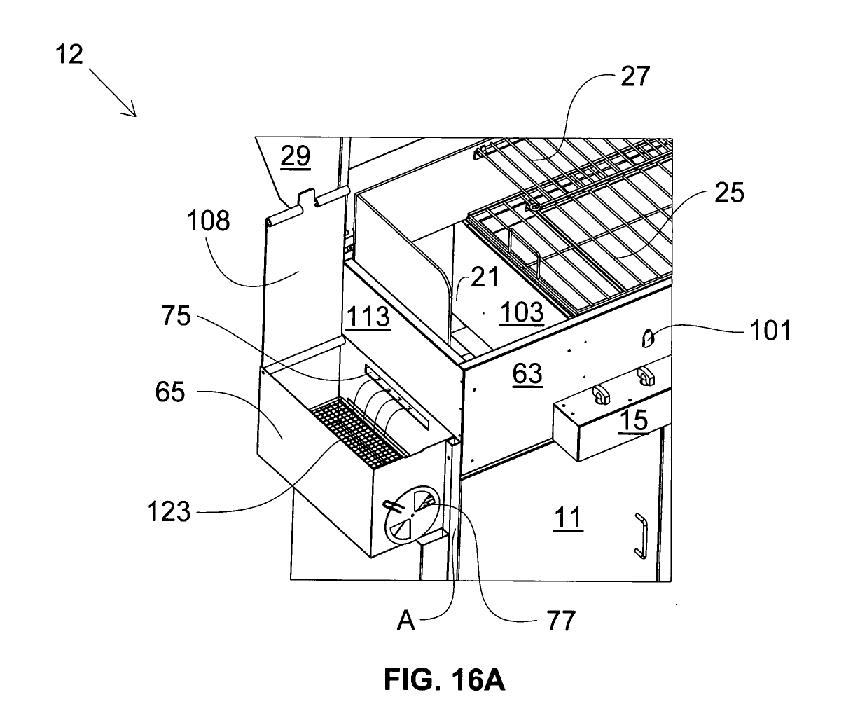

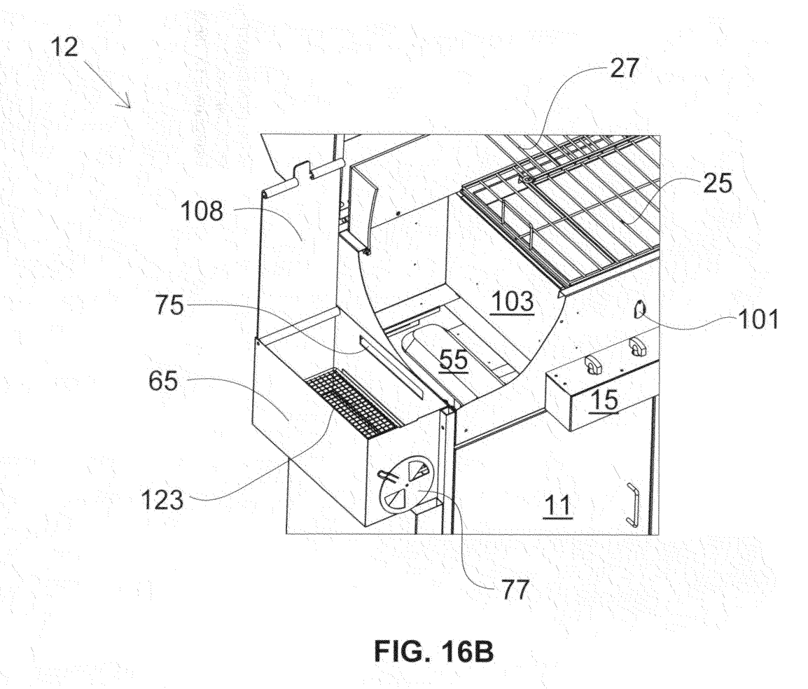

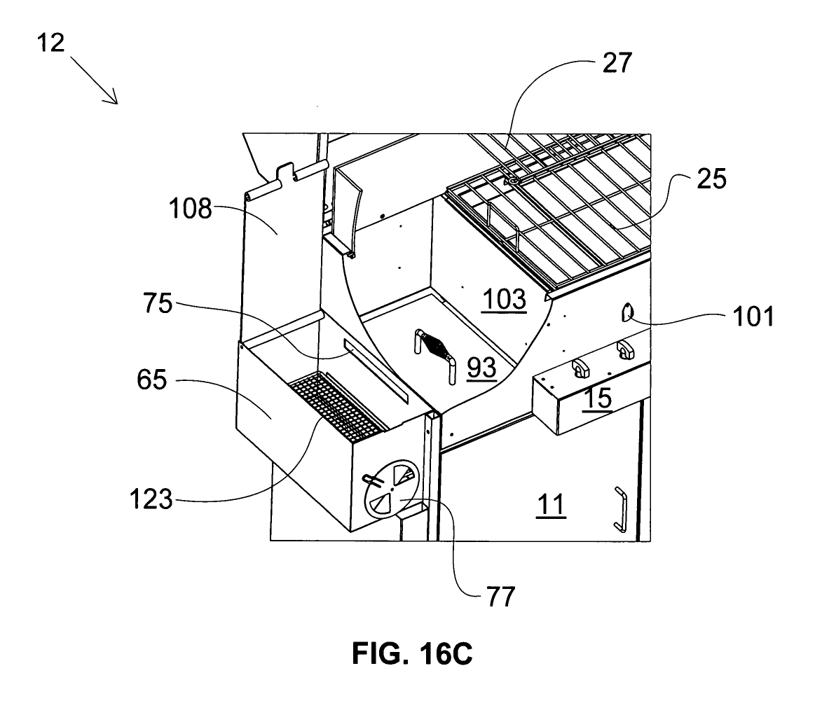

FIG. 11 is a perspective view of a device 12 according to some embodiments of the disclosure, wherein heat and/or smoke are not generated substantially within or substantially at the bottom of the first chamber 21, but rather are supplied from an external fire box 65 disposed at and in some embodiments attached to left side of device 12. In such embodiments, one of which is also shown in FIG. 16A, heat generated by combustion of a fuel source such as charcoal, wood or other carbonaceous fuels caused to be present in fire box 65 is conveyed into first chamber 21 through an opening 75 as shown in pertinent part in FIGS. 16A, B, C. The structure of a device shown and described in reference to FIG. 11 is similar in many regards as previously-described embodiments, with the addition of the feature of the fire box 65 and an opening 75 through which heat and/or smoke is conveyed from fire box 65 into first chamber 21. In some embodiments, fire box 65 is permanently affixed to device 12. In such an embodiment, first chamber 21 becomes a conduit of heat from fire box 65. In some embodiments fire box 65 includes an adjustable vent 77 having the same vent structure as previously described, although any adjustable vent known in the art as being suitable for throttling the amount of air which is permitted to enter such fire box 65 when a carbonaceous combustible substance is disposed within fire box 65. In some embodiments, fire box 65 is equipped with a cover 108, which in some embodiments comprises sheet metal, which is optionally hingedly attached thereto, which cover 108 functions to enable selective opening and closing of the top of fire box 65. Also shown in FIG. 11 is second surface 19, first chamber 21, adjustable vent port 41, cover 29, left door 11, right door 13, first cooking surface 25 and optional cooking surface 27. Fire box 65 includes a floor, and a mesh, grill, screen or like support for supporting carbonaceous combustible materials placed therein off of its floor.

FIG. 12 is a right side section view of a device 10 according to some embodiments of the disclosure, taken at the section indicated in FIG. 7. Shown in FIG. 12 are the respective locations and arrangements of various elements of a device 10 according to the disclosure, including partition pan 51 present in a functional position, food cooking surface 25, second chamber 23, burner 53, and below-grid exhaust port 45. A portion of front panel 63 is shown, including pilot holes 171, and also control panel 15, valve control knobs 47, gas venturi 105, and burner supports 107, 109. In some embodiments, burner supports 107, 109 are rails which are comprised of metal each having a first end and a second end, wherein the first and second ends of the burner supports 107, 109 are each rigidly affixed to the device 10 using conventional attachments and sufficient that burners 53 rest atop of burner supports 107, 109 in known fashion. In some embodiments, burner supports 107, 109 are present on subcombination 16, being attached at their first end portions to wall 156 (FIG. 3) and to right panel 115 at their second end portions.

A given space S within the second chamber 23 is in fluid communication with the atmosphere surrounding device 10 through the below-grid exhaust port 45. Ignition of burner 53 with partition pan 51 in place as shown in FIG. 12 generates gaseous combustion products, which may exit space S within second chamber 23 via below-grid exhaust 45, to the surrounding atmosphere. In some embodiments, four walls comprising portions of rear panel 169, right panel 115 (FIG. 3), wall 103 and front panel 63 surround second chamber 23. In these and other functionally-equivalent embodiments partition pan 51 when present as shown in FIGS. 10 and 12 can be considered as a roof of second chamber 23, and the area defined by the aforementioned four walls at the bottom portion (BT2 in FIG. 3) of second chamber 23 is open to the volume in which fuel vessel 39 is present as shown in FIG. 5, wherefrom is drawn secondary air for combustion of the fuel. In some embodiments, air is drawn from around the drip pan in the area above the propane tank as shown in FIG. 5. In some embodiments there is a gap of about six millimeters above the drip pan and the bottom BT2 of subcombination 16. Air can also enter second chamber 23 through the holes 173 in panel 63 as shown in FIG. 3.

FIG. 13 is a left side sectional perspective view of a device according to some embodiments of the disclosure at the location indicated in FIG. 5. In FIG. 13 are shown the respective locations of front panel 63, control panel 15, second surface 19, first chamber 21, second chamber 23, wall 103, cover 29, burner(s) 55, adjustable vent port 35, and floor panel 67. In this embodiment cover 29 is seen to comprise a dual-wall structure, i.e., cover 29 is not in this embodiment comprised of a single layer of sheet metal, but rather comprises a first outer layer of sheet metal and a second inner layer of sheet metal, having a space disposed between these layers.

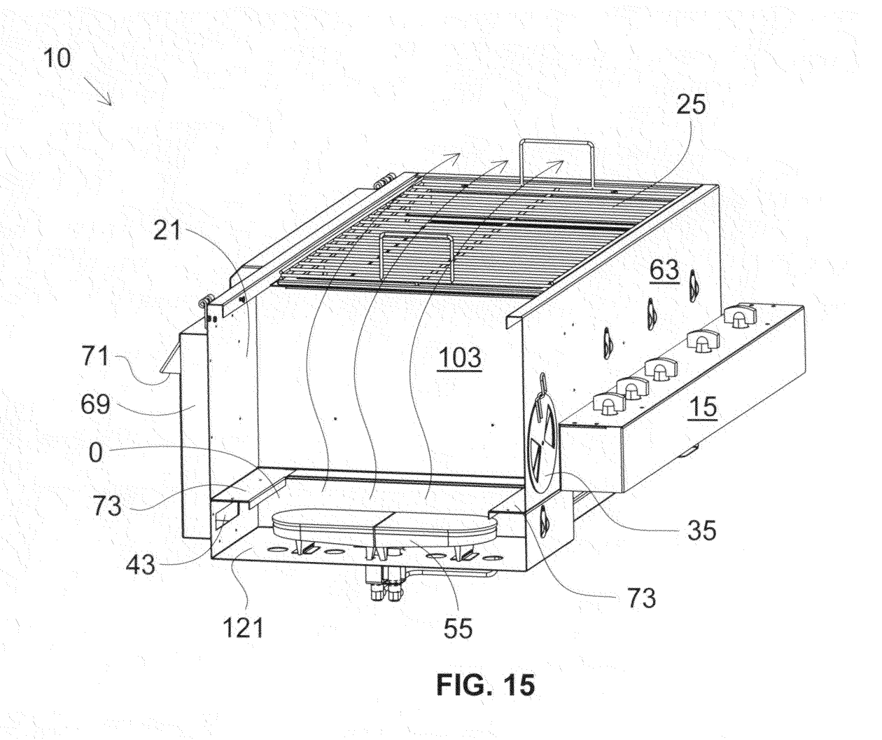

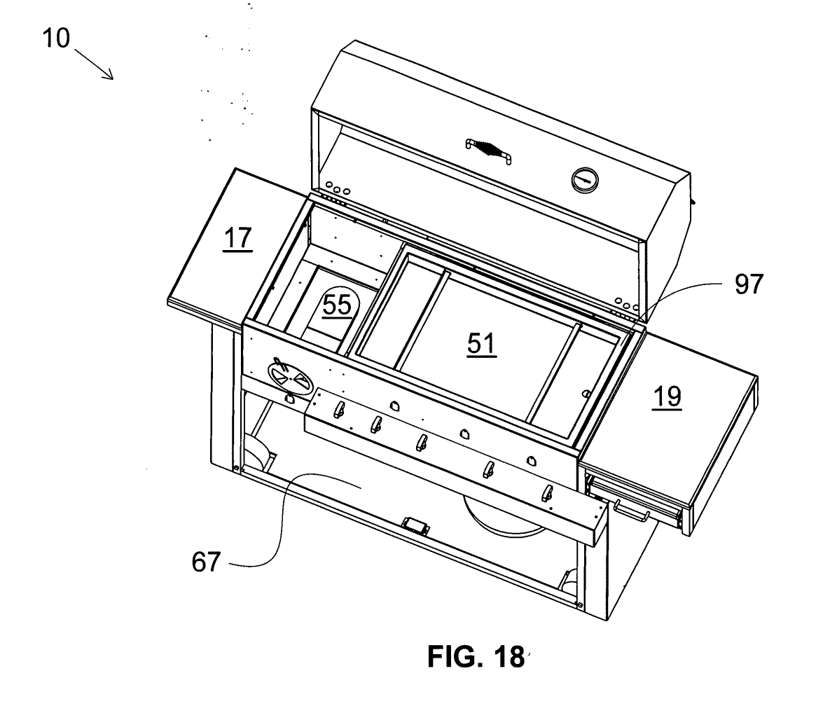

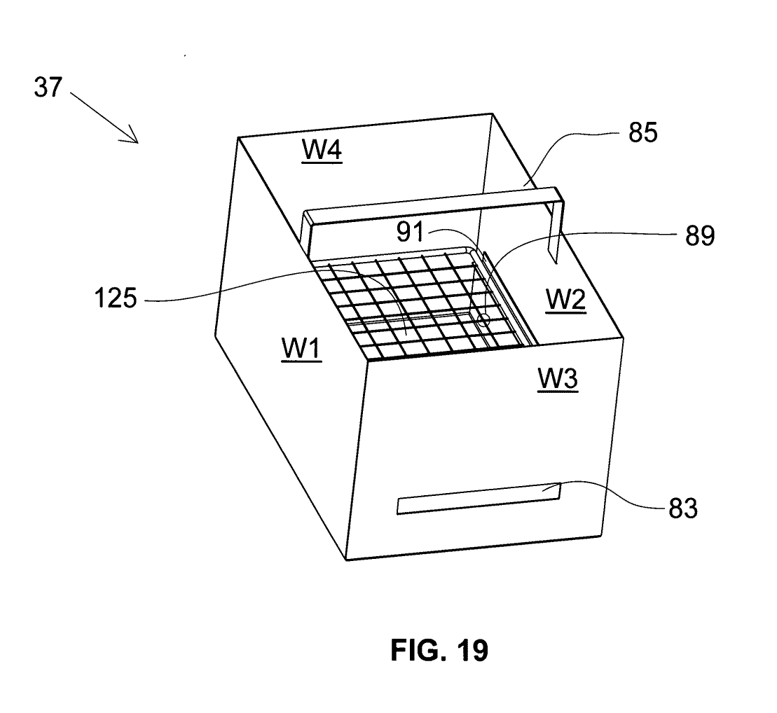

FIG. 14 is a side section perspective view of a device according to some embodiments of the disclosure wherein cover 29 has been omitted for clarity, showing the respective locations of front panel 63, control panel 15, food cooking surface 25, and optional cooking surface 27. The view of FIG. 14 is essentially a close-up of the view shown in FIG. 13, with burn box 37 (FIGS. 19, 20, 21) sectioned, being present within first chamber 21. The primary function of burn box 37 is to act as a container in which at least one carbonaceous combustible material (including without limitation pieces of wood, charcoal and mixtures thereof) may be burned; however, burn box 37 is further provided with an intake vent 83 and is configured sufficiently that intake vent 83 is disposed towards adjustable vent port 35 on front panel 63 of device 10 when the burn box 37 is present in first chamber 21, as shown. When present, the flat bottom of burn box 37 seals opening O (FIG. 15), thus preventing ingress of air from said opening O. This arrangement provides for the throttling of the amount of air or airflow that is permitted to enter vent 83 of burn box 37, and hence the rate of combustion of a solid fuel present in burn box 37. Thus, when a solid fuel is placed into burn box 37 and ignited, and burn box 37 is caused to be disposed in first chamber 21 with adjustable vent port 35 opened sufficiently to admit air necessary for combustion, heat is produced in first chamber 21, capable of causing a flow of heat as was shown in FIG. 10 when cover 29 is in its closed position. Such flow of heat is further controlled and controllable by adjusting the degree of opening of adjustable vent port 41 present on cover 29, when closed. Although adjustable vent ports 35, 41 are shown disposed in particular locations in the various drawings appended hereto, in alternate embodiments adjustable vent port 41 is optionally disposed on the rear portion and/or side or front wall portion of cover 29 subject to the proviso that such location of an adjustable vent thereon is conducive to maintenance of a heat flow over a food item desired to be cooked or smoke-treated that is disposed on either or both of food cooking surface 25 and optional cooking surface 27. Similarly, vent 83 on burn box 37 may be disposed at any other suitable location on burn box 37 sufficient to admit air for combustion of a carbonaceous combustible material, provided that adjustable vent port 35 is present in a location effective for throttling the air that is permitted to enter burn box 37. In another embodiment, adjustable vent port 35 is disposed on the left panel 113 of device 10 when a subcombination of FIG. 3 or its functional equivalent is present. In another alternate embodiment, adjustable vent port 35 is disposed on the back panel 169 of device 10 when a subcombination of FIG. 3 or its functional equivalent is present.

Further shown in FIG. 14 is burner(s) 55, which, as burners 53, in some embodiments are conventional, partially-aerated gas burners. In some embodiments there is a safety exhaust port 43 present through a wall of first chamber 21 that is in fluid communication with and vented to the ambient atmosphere surrounding device 10, optionally through a safety exhaust duct 69 to safety exhaust outlet 71, which outlet 71 is essentially an opening at the end of duct 69 when present. In some embodiments safety exhaust port 43 is present at a location that is beneath the plane of floor 73 in first chamber 21. In some embodiments, safety exhaust duct 69 is comprised of u-shaped sheet metal having closed ends that is attached to rear panel 49 as shown and outlet 71 is a hole in the body of the duct, and is shrouded to preclude entry of rain, debris, etc. by an optional awning. Safety exhaust port 43 functions effectively as a pressure switch by allowing burner 53 to safely vent combustion product gases in the event burn box 37 is present in first chamber 21 and hence covering opening O, and burner 53 somehow becomes ignited. Safety exhaust port 43 also functions to vent combustion product gases to the ambient surroundings when burn box 37 is not present in first chamber 21 and when adjustable vent port 41 on cover 29 is inadvertently closed of insufficiently open for full venting of combustion product gases generated. In some embodiments safety exhaust port 43 is present beneath floor 73 as shown.

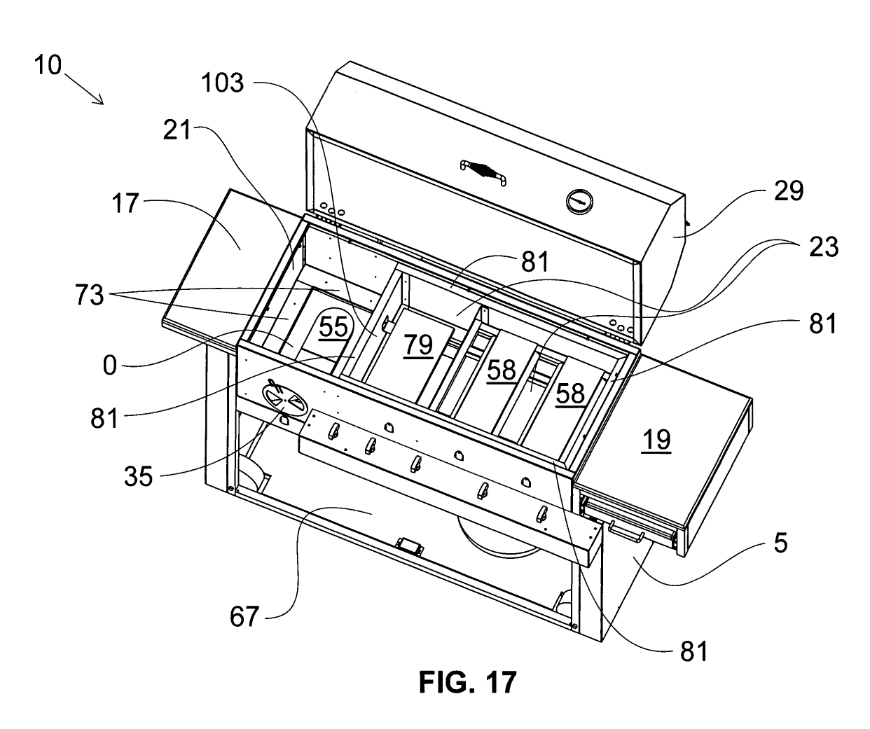

In some embodiments, when burn box 37 is installed as shown in FIG. 14, it is possible that burner(s) 55 may be inadvertently ignited by a user. Since the bottom of burn box 37 is in some embodiments substantially flat, when installed as shown in FIG. 14 it covers opening O, (FIG. 15), present immediately above burner 55, the opening O being an aperture disposed through the floor 73 (FIG. 17) of first chamber 21, thus providing a barrier between the space surrounding and adjacent to burner 55 and first chamber 21. The gases of combustion of burner 55 if inadvertently ignited with burn box 37 in place as shown in FIG. 14 are then vented to the atmosphere through safety exhaust port 43 and are precluded from entering the volume above food cooking surface 25. With burn box 37 in place as shown in FIG. 14, air sufficient to support combustion of solid fuel is precluded from entering first chamber 21 through opening O, and instead combustion air for throttling can only enter burn box 37 via adjustable vent port 35 and vent 83. In some embodiments, floor 73 (FIG. 17) contains precision raised edges at the perimeter of floor 73 upon which burn box 37 can be made to rest, to provide the a barrier to air flow as described above. It is generally desirable that opening O be of sufficient aperture to permit combustion product gases emitted from burner(s) 55 when combustion is occurring thereat, to escape upwards into first chamber 21 when burn box 37 is not present therein. Accordingly, generally speaking, the aperture size of opening O is of larger dimension than burner(s) 55 when viewed from above. In some embodiments, opening O is rectangular in shape. In other embodiments, it is oval in shape but the present disclosure includes all shapes of openings O sufficient to provide the functionality described. When burner(s) 55 are circular in dimension as viewed from above, opening O is in some embodiments circular, but of larger radius than burner(s) 55.

According to some embodiments of operation of device 10 as shown in FIG. 14, burn box 37 may be simply lifted out by its handle 85 or omitted from first chamber 21, as FIG. 15 shows a side section perspective view of a device 10 according to the embodiment of FIG. 14 but having no burn box 37 present in first chamber 21. In the case of the arrangement of FIG. 15 with no burn box 37 present in first chamber 21, when combustion is occurring at burner(s) 55 and cover 29 (FIG. 1) closed, heat from the burner flame rises through the rectangular opening O in floor 73 and flows in the direction shown by the arrowed lines, over food cooking surface 25 and eventually to the atmosphere through adjustable vent port 41.

These various features as shown and described in relation to the drawings figures, in combination, provide novel function in a device 10 over what has been heretofore known in the cooking wares arts. In some embodiments, a cut of meat such as a beef brisket, to cite one non-limiting example of a food item, is placed on food cooking surface 25, and partition pan 51 is present in its functional location immediately beneath food cooking surface 25 (FIGS. 10, 18). Burn box 37 is charged with pieces of wood, charcoal or mixtures thereof, which is ignited, burn box 37 being already disposed within or subsequently placed into first chamber 21. Cover 29 is closed and adjustable vent ports 35, 41 are adjusted so that a slow but steady stream of smoke and heat from combustion of the wood or other solid fuel present in burn box 37 passes predominantly above the food item and exits adjustable vent port 41. By judicious adjustment of the openings of the adjustable vent ports 35, 41 the wood contained in a single charging of burn box 37 provides heat and smoke to food present on food cooking surface 25 (and optionally on surface 27) for a time period of up to about six hours, as may be desired. In conventional American Barbeque, cuts of meat are desirably subject to heat and smoke from burning wood or charcoal for as much as 22 hours time, which requires careful attention by an operator. By the present disclosure it is now possible to impart natural wood smoke flavor to the cut of meat being cooked with a single charge of burn box 37, followed by subsequent removal of burn box 37 and ignition of burner(s) 55 disposed beneath first chamber 21. This provides the operator with the opportunity to continue cooking the cut of meat using overhead heating, without the necessity of the time investment and caution normally associated with tending to stoking a conventional barbeque set up for time periods in excess of twenty hours. Use of a device having structural features as provided herein enables an operator to cook using the contents of burn box 37 as fuel and flavorant, remove burn box 37 when its charge of carbonaceous combustible material is depleted, and continue cooking for an additional approximate 16 hours or as long as desired using only natural gas or propane-fed heat, which requires little or no attendance once the flame height and vent openings are appropriately adjusted, as determined by the operator. Thus, by a device according to the disclosure, a person may start to cook a beef brisket at 3 p.m. in the afternoon using the carbonaceous contents of burn box 37 as fuel until about 9 p.m., at which time burn box 37 is removed, burner 55 is ignited, flame height and vent openings are adjusted, and the cooking of the brisket continued solely by the flame at burner 55. The operator may turn in for the night, arise in the morning, permit the device to continue cooking the meat until about 1 p.m. the next day, at which time the brisket is ready to eat, with only minimal examination of the meat in the morning being necessary. Contrasted to conventional methods of preparing barbeque, which require near constant monitoring and frequent re-stoking of wood fuel, use of a device as provided herein requires only minimal interaction by the operator to obtain high quality wood-smoked edible meats.

Burner(s) 55 in FIG. 15 is in some embodiments supported by first chamber sub-floor 121, upon which it rests, the plumbing feeding to burner(s) 55 and all other burners provided on a device provided herein being conventional plumbing generally known in the art. Thus, in some embodiments burner(s) 55 is disposed itself in a chamber, bounded by left side panel 3, wall 103, front panel 63, rear panel 49, and has floor 73 with opening O as its roof or ceiling. An alternate interpretation of the structure of such embodiment is that burner 55 is disposed at the bottom portion of first chamber 21, resting on sub-floor 121, with floor 73 having an opening and being configured to support burn box 37. In some embodiments, burner(s) 55 is housed in its own separate small box attached underneath the main body of device 10, which is clear from viewing the difference between FIGS. 4 and 5. This separate small box can be viewed as comprising an extension of left panel 113, an extension of wall 169, extension of wall 103 and extension of front panel 63 in the appropriate locations shown. In such embodiments, rear panel 49 forms the rear panel of the storage area and does not see heat and thus is not part of this separate small box. In such embodiments this separate small box is one means to extend the depth of first chamber 21, to provide sufficient depth to accommodate both burner(s) 55 and burn box 37. Regardless of which interpretation is adopted, in device according to some embodiments of the disclosure, first chamber 21 is substantially shaped to comprise a volume of approximate rectangular shape having an open top, is surrounded by four side walls and includes a burner 55 at its bottom, which may be considered as a floor. There is a support (floor 73) upon which burn box 37 may be caused to reside above burner 55, which support is configured to sealingly engage the bottom of burn box 37 sufficient to substantially prevent combustion product gases emitted by burner 55 (when combustion is occurring) from entering first chamber 21, when burn box 37 is positioned atop the support, which support may be considered as a floor upon which burn box 37 may be selected to reside. In addition, such an arrangement prevents ingress of air into burn box 37, enabling effective throttling of air into the burn box 37 via adjustable vent port 35.

FIG. 16A is a perspective view of a portion of a device 12 according to an alternate embodiment of the disclosure, having features previously shown and described in reference to FIG. 11 and comprising a fire box 65 attached to a cooking device such as device 10 at left panel 113. The function of fire box 65 is analogous to the function of burn box 37, to contain carbonaceous combustible material and maintain the combustible material in a fixed position while it is burned and provide overhead heat and smoke to a food item disposed on cooking surfaces 25 and/or 27. In such embodiments, there is an adjustable vent 77 present on fire box 65 to enable throttling of air admitted into fire box 65. Fire box 65 is equipped with a cover 108, which in some embodiments is a flat cover, that prevents heat and smoke from being vented to the general atmosphere surrounding device 12. Provision of opening 75 in left panel 113 and also effectively the side wall of fire box 65 permits heat and smoke generated in fire box 65 to enter into first chamber 21 as indicated by the arrowed lines in FIG. 16A, and to pass over food cooking surface 25 and out through adjustable vent port 41 (FIG. 10) when cover 29 is closed, thus smoking and cooking a food item present on a food cooking surface herein. Burn box 37 and fire box 65 are each in some embodiments provided with a mesh, screen, grate, grill or other such fixture or provision in their bottom portions, such as at 123 in fire box 65 for the purpose of supporting the carbonaceous combustible material. Once carbonaceous combustible material present in fire box 65 has been consumed during a cooking process using a device 12 provided herein, further cooking and/or smoking of a cut of meat or other foodstuff present on food cooking surface 25 is in some embodiments effected by igniting burner 55 present in first chamber 21 (FIG. 16B). Effective air throttling (FIG. 16C) is achieved by the presence of a handled lid 93 or other barrier that covers up opening O to prevent stray air from entering first chamber 21 through crevices present around gaseious fuel plumbing conduits, etc. In some embodiments first chamber 21 is present in embodiments comprising a fire box 65. When present as shown in FIGS. 16A, 16B, 16C, first chamber 21 functions as a conduit through which heat and smoke emitted from fire box 65 travel via opening 75 pass on their way out of the device through adjustable vent port 41 when cover 29 is in its fully-closed position and partition pan 51 is in the location shown in FIGS. 10 and 18.

FIG. 17 is an overhead perspective view of a device 10 according to some embodiments of the disclosure. In this FIG. 17 are shown the respective locations of first chamber 21 and second chamber 23. First chamber 21 is shown as having floor 73 present, which floor 73 includes an opening O, upon which burn box 37 may be placed, as desired, burner(s) 55 being disposed also in first chamber 21, beneath floor 73 and resting on a sub-floor 121 (FIG. 15). In some embodiments floor 73 is an appropriately-shaped piece of sheet metal having an aperture, that is attached such as by welding, etc. sufficiently to the inner walls of first chamber 21 to support burn box 37. Second chamber 23 includes walls comprising back panel 169 (FIG. 3), front panel 63, right panel 115, and wall 103. There is provision for supporting partition pan 51 in a functional position shown in FIGS. 10, 18, such provision in some embodiments comprising a rim 81, which may be thought of as a lip, that is disposed along the perimeter of second chamber 23 substantially at its uppermost portion, which rim 81 is configured to receive the perimeter lip 97 (FIG. 22) of partition pan 51 and maintain partition pan 51 in position by the force of gravity acting on the perimeter lip 97 of partition pan 51 atop rim 81, when it is desired to so locate partition pan 51 in said second chamber 23. Thus, rim 81 is capable of acting as a support for partition pan 51 and food cooking surface 25, holding one or both of these useful elements substantially at the top portion of second chamber 23. When partition pan is installed, it prevents ingress of air from beneath itself into second chamber 23, enabling effective control of air throttling through the adjustable vents. However, other functionally-equivalent support structure that is sufficient to maintain either and/or both of partition pan 51 and food cooking surface 25 substantially at the top portion of second chamber 23 is useful in a device described herein, including embodiments employing ledges, hooks, shelves and any other known and sufficient support structure, which may be collectively referred to as a cooking surface support structure herein, although such structures also support partition pan 51. Rim 81 falls within this category of cooking surface support structures. In some embodiments, food cooking surface 25 is a rectangularly-shaped grill, that is subsequently placed atop perimeter lip 97 of partition pan 51 when present. When partition pan 51 is not desired to be present but is to be stowed, food cooking surface 25 is dimensioned sufficiently that it may be placed directly atop rim 81, for cases when burners 53 (FIG. 12), 79 are to be used to grill foods placed on cooking surface 25 in the conventional sense. Burners 53, 55, 79 may be conventional gas burners and in alternative embodiments may comprise radiant burners, or any other burner type known in the art as being useful for providing flame heat suitable for cooking food materials, but may also comprise electric heating elements. In some embodiments, burner 79 is a radiant burner that takes advantage of efficient secondary air combustion of the gas fuel known to burners of this type, and burners 53, 55 are conventional partially-aerated gas-grill burners. In some embodiments, the top edge of wall 103 functions as a portion of rim 81. Also shown in FIG. 17 are first surface 17, second surface 19, floor panel 67, adjustable vent port 35, and cover 29 in an open position. The burners 53 herein provided may be fitted with or alternately covered by shrouds 58 above them which serve to spread and radiate the heat they emit while preventing dripping meat juices and the like from dripping onto the burners and potentially fouling them, as such heat-spreading shrouds and means for their deployment are generally known in the art. In FIG. 17, both burners 53 are covered by a shroud 58. Radiant burner 79 is exposed without a shroud as is typical for radiant burners.

FIG. 18 is an overhead perspective view of a device 10 according to an embodiment of the disclosure as was shown and described in relation to FIG. 17, but having partition pan 51 in place with its perimeter lip 97 residing upon rim 81 (FIG. 17), cooking surface 25 being omitted for clarity.

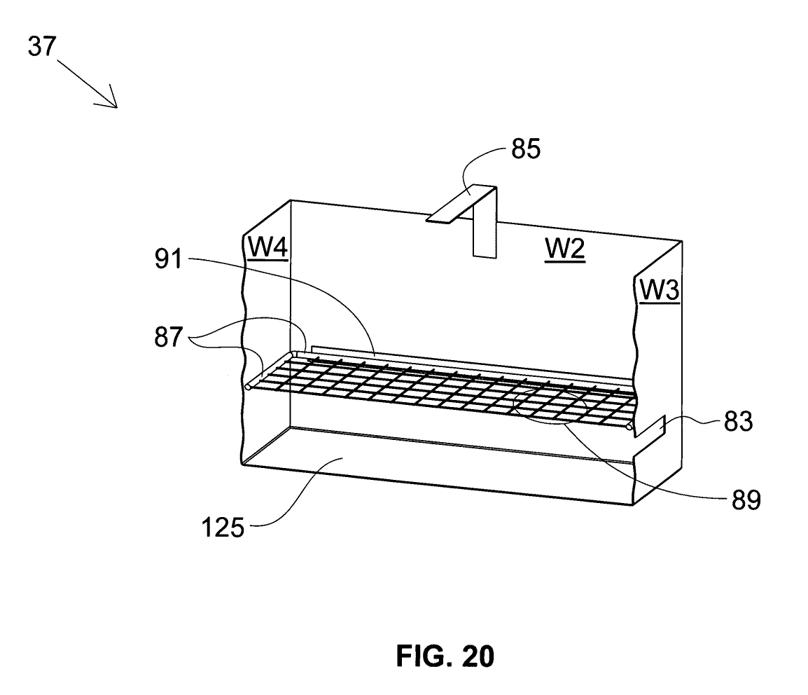

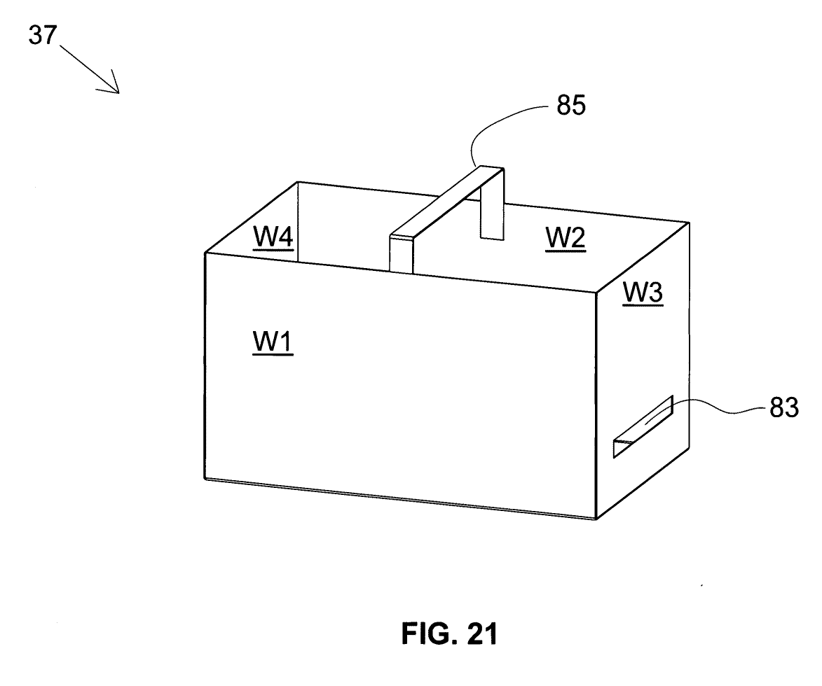

FIG. 19 is an overhead perspective view of a burn box 37 useful in combination with devices according to the disclosure. In some embodiments burn box 37 is shaped as a rectangular box having four walls W1, W2, W3, W4 and a floor 125, all of which elements of burn box 37 comprise sheet metal attached to one another using conventional means of attachment, or provided by bending a single piece of sheet metal stock. However, an article as provided herein is not limited to the use of sheet metal for this purpose, as the burn box 37 can be made of cast aluminum, stamped aluminum or stainless steel as desired. There are mesh supports 91 which may comprise pieces of sheet metal, rods, hooks, angle stock etc. disposed on the inner walls of burn box 37, sufficient to support a mesh 89, upon which mesh 89 a carbonaceous combustible material may be placed. In some embodiments, mesh supports 87 are provided, which are rods which are welded to mesh 89, and the rods rest on angle support 91 (FIG. 20). In alternate embodiments mesh 89 may comprise a grill, grate, series of bars running across the inner dimension(s) of burn box 37, or any other known suitable structure for supporting a combustible material within burn box 37. There is a vent 83 disposed through one of the walls of burn box 37 as shown in FIGS. 19, 20, sufficient for admitting air for combustion into burn box 37 when placed in device 10 as shown in FIG. 14. Burn box 37 also includes a handle 85 to facilitate its placement into, or removal from, first chamber 21 after the combustible carbonaceous material is spent. When carbonaceous material has been reduced to cold ashes, burn box 37 may be removed and turned upside down in an appropriate location to conveniently dispose of ash. This overcomes the objectionable clean-up aspect of charcoal use. FIG. 20 shows a cutaway view of burn box 37 according to the embodiment shown in FIG. 19 for clarity showing the respective locations of floor 125, mesh support(s) 87 residing on a piece of angle stock 91 that is itself attached to wall W1, W2, W3, and W4 as desired or necessary for support of mesh 89. FIG. 21 is a perspective view of burn box 37 of FIGS. 19, 20, in this embodiment handle 85 being attached thereto by spot welds.

In FIG. 22 is provided a perspective view of a partition pan 51 useful in combination with a device according to the disclosure. Partition pan 51 is shaped as a typical pan or tray, having a perimeter lip 97 that extends about the generally rectangularly-shaped perimeter of the partition pan 51, which is dimensioned sufficiently to reside on rim 81 of a device according to the disclosure, when so desired by a user or operator, and which perimeter lip is configured to function as a surface upon which a food cooking surface 25 may be placed. There are also support struts 93 attached to the inner wall portions of the partition pan 51 which add structural strength and also provide an easy means for lifting partition pan 51 when it is desirably removed such as for cleaning or for operation of a device 10 as provided herein as a conventional grill. Partition pan 51 also optionally includes a drain hole 95 through which meat juices and the like may drip, and fall into drip pan 99 for collection, drip pan 99 being readily removable from device 10 such as by virtue of its being slidably mounted thereon in the fashion of a drawer, as drip pans in grills and the like are generally known in the art as being so mounted.

In an alternate embodiment, drain hole 95 of partition pan 51 is either absent or plugged and that partition pan is filled partially with water and cooking surface 25 or a metal sheet having a plurality of holes disposed therethrough is placed atop perimeter lip 97. Burners 55, 79 are ignited and a food item that is desired to be steamed, such as clams, lobsters, etc. are placed on such surface or sheet and are conveniently steamed. Moreover, the interior of the cover may additionally be steam cleaned in this fashion.

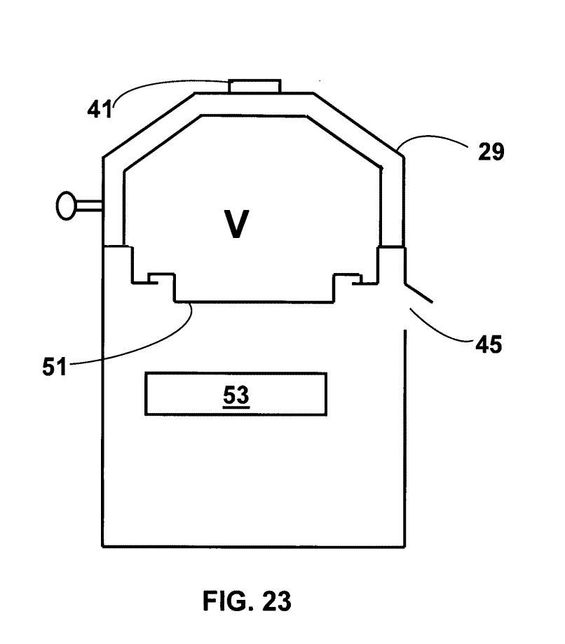

FIG. 23 shows a side schematic view of a device according to some embodiments of the disclosure with cover 29 in a closed position and partition pan 51 in its functional position disposed above burner 53. The double-walled cover and partition pan together provide that the cooking chamber including volume V is substantially insulated from ambient weather and thus the impact of wind gusts and the effect of changes in ambient conditions upon the conditions present within volume V are minimized. Thus, the ideal case is approached wherein the heat input to volume V is equal to the heat vented from volume V. Moreover, the double walled cover 29 limits the heating of the outer layer of the cover, which increases efficiency and temperature stability.

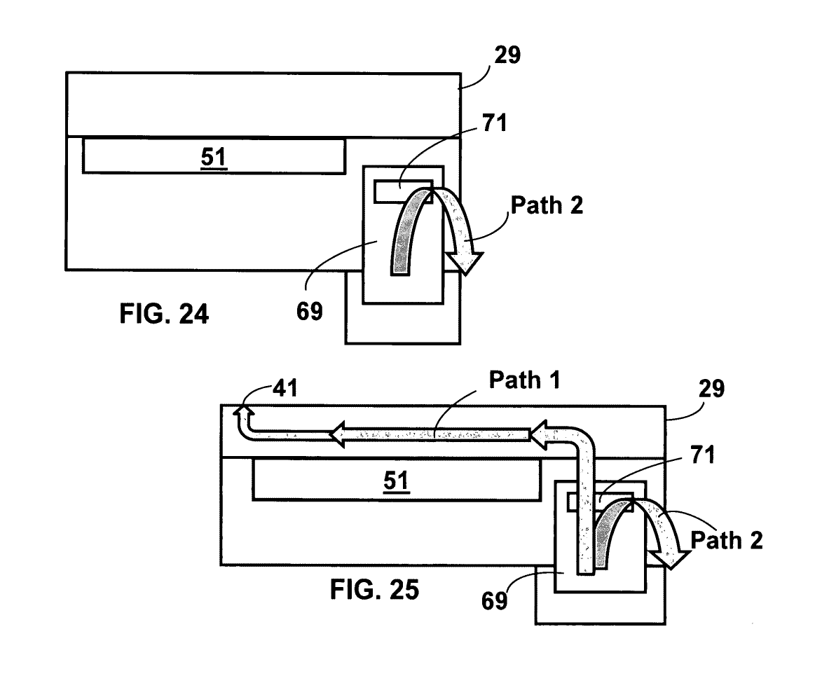

FIG. 24 shows a schematic view taken from the rear perspective of a device according to some embodiments of the disclosure. In this depiction, if burn box 37 is disposed within first chamber 21 and if the operator of the device inadvertently ignites burner 55, then gaseous combustion products exit the unit via path 2 indicated by the arrow, through the safety exhaust duct 69 and out to the surrounding atmosphere.

FIG. 25 shows a schematic view taken from the rear perspective of a device according to some embodiments of the disclosure. In this depiction, wherein burn box 37 is not present in first chamber 21 and partition pan 51 is present in its functional position, when vent port 41 on top of cover 29 is closed, then combustion product gases exit the device via path 2, out through safety exhaust duct 69. If adjustable vent port 41 is opened, then combustion product gases exit the device via path 1. The arrangement provided by a device according to the disclosure including these two potential paths of flow of combustion product gases yield sufficient exhaust flow for burner 55 and ANSI acceptable carbon monoxide levels.

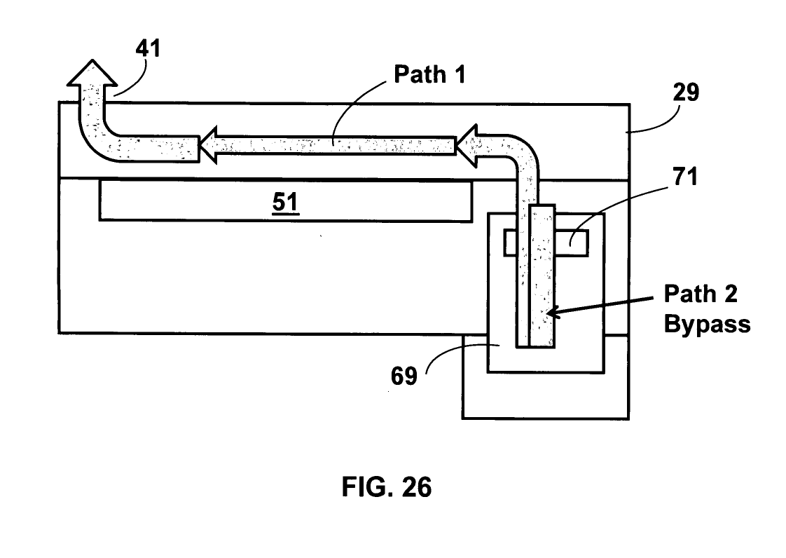

FIG. 26 shows a schematic view taken from the rear perspective of a device according to some embodiments of the disclosure with partition pan 51 in its functional position and burn box 37 not present within first chamber 21. In such arrangement, one mode of operation is for adjustable vent port 41 to be in its fully opened position, thus making the effective resistance to flow through path 1 much less than that for path 2, causing heat and combustion product gases to pass across cover 29 and to the atmosphere through adjustable vent port 41 when combustion is occurring at burner 55.

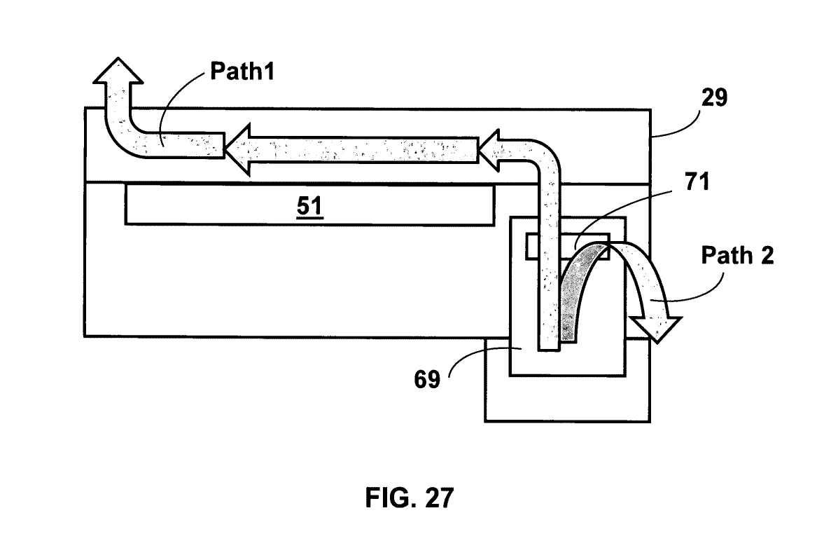

FIG. 27 shows a schematic view taken from the rear perspective of a device according to some embodiments of the disclosure with partition pan 51 in its functional position and burn box 37 not present within first chamber 21. In such arrangement, when adjustable vent port 41 is in a sufficiently partially-opened position, the effective resistance to flow through path 1 can become on par with that for path 2, causing some heat and combustion product gases to pass across cover 29 and to the atmosphere through adjustable vent port 41, and some heat and combustion product gases to pass out of the device through safety exhaust duct, when combustion is occurring at burner 55.

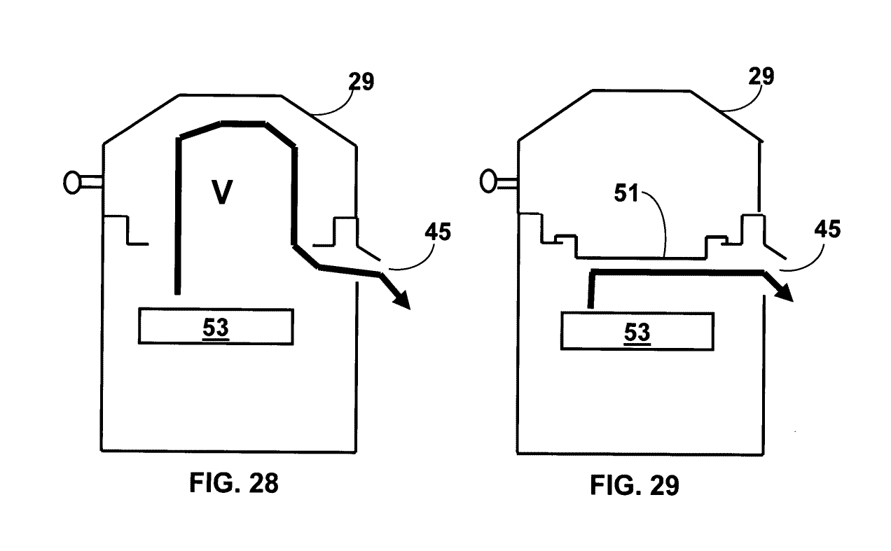

FIG. 28 shows a side schematic view taken from the right side perspective of a device according to some embodiments of the disclosure wherein partition pan 51 is not present in its functional position and combustion is occurring at burner 53. In such arrangement, combustion product gases and heat follow the path of the arrow, up into volume V and eventually exiting the device via below-grid exhaust port 45. In some embodiments, gas burners are located slightly forward towards the front of the device as shown, such that rotating convection currents experience a low lowered resistance in their travel to the below-grid exhaust port 45.

FIG. 29 shows a side schematic view taken from the right side perspective of a device according to some embodiments of the disclosure wherein a partition pan 51 is present in its functional position and burner 53 is inadvertently ignited. In such arrangement, combustion product gases and heat follow the path of the arrow, and quickly exiting the device via below-grid exhaust port 45.

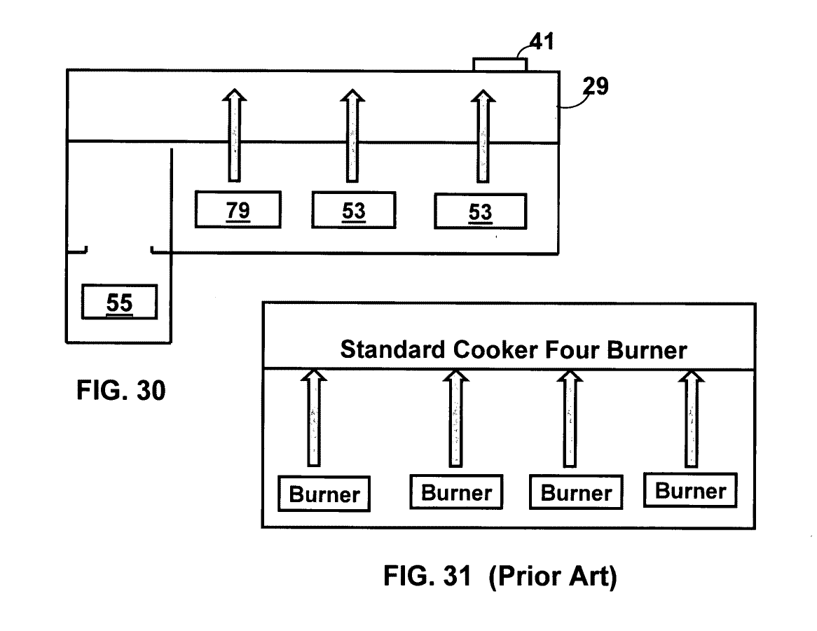

FIG. 30 shows a schematic view taken from a frontal perspective of a device according to some embodiments of the disclosure, being operated in grill mode with partition pan 51 not present in its functional position, but with a cooking surface such as 25 resting on rim 81 previously described, and wherein combustion is occurring at burners 53, 79. In such mode, heat moves upwardly and out of opened adjustable vent port 41 as well as below-grid exhaust port 45 when cover 29 is closed, and directly upward to the atmosphere when cover 29 is open. This is analogous to when a conventional grill of the prior art as shown in FIG. 31 is being used to grill, FIG. 31 being a schematic view taken from a frontal perspective of a conventional gas or other grill according to the prior art.

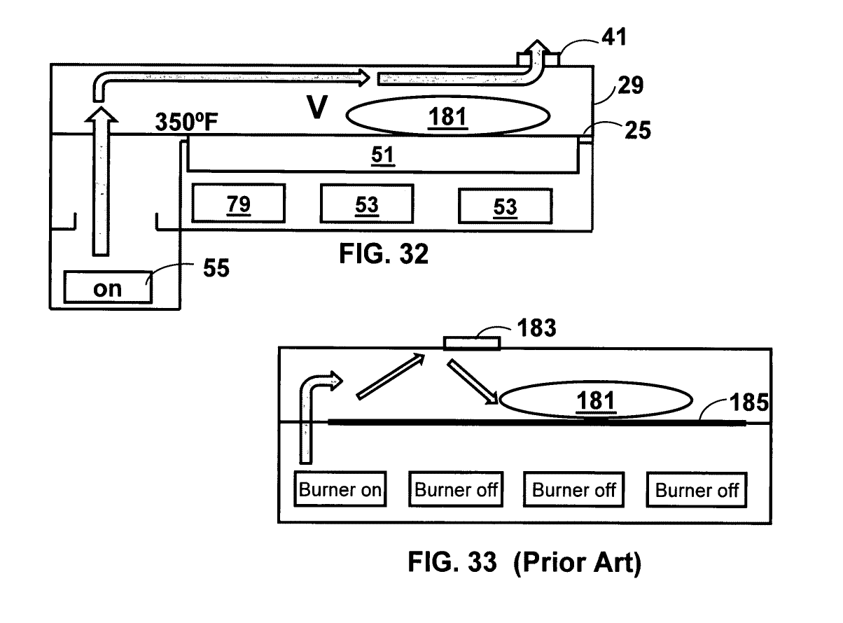

FIG. 32 shows a schematic view taken from the front perspective of a device according to some embodiments of the disclosure with partition pan 51 in its functional position, burn box 37 not disposed in first chamber 21, and with combustion occurring at burner 55. Heat and combustion product gases travel from left to right as shown by the arrowed line and escapes through adjustable vent port 41. The cut of meat 181 present experiences a temperature of about 350 degrees Fahrenheit to about 450 degrees Fahrenheit, depending on the adjustment of the flame provided by burner(s) 55. In addition, a cut of meat present on food cooking surface 25 experiences reflected infrared energy from both cover 29 and partition pan 51, thus, partition pan 51 also is an effective heat radiator, providing a more even heating of the meat 181 than prior art devices. Moreover, in such mode, partition pan 51 precludes outside air from entering volume V. This is in contrast to the prior art grill shown schematically in FIG. 33 in which combustion product gases and heat indicated by the arrowed lines frequently escape the unit prior to passing over a food item placed on its cooking surface 185, typically a grill or grate. Such prior art arrangements typically create a temperature differential across these grills, in addition to drawing excessive amounts of air which tend to have a drying effect on foods prepared therein.

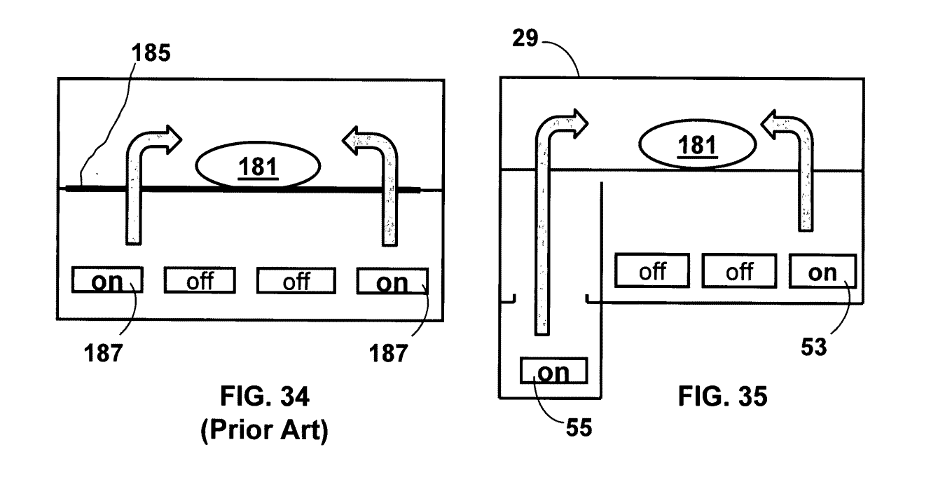

FIG. 34 shows a schematic view taken from the front perspective of a device according to the prior art being operated in high-temperature roasting mode, typically about 400 degrees Fahrenheit to about 500 degrees Fahrenheit. FIG. 35 shows a schematic view taken from the front perspective of a device according to some embodiments of the disclosure also being operated in high-temperature roasting mode, wherein a cut of meat 181 is disposed on cooking surface 25, partition pan 51 is not present in its functional position, and combustion is occurring at burners 53, 55. This mode is of use when cooking duck to render fat, and prime rib roasts in which the outside is desirably charred and the inside of the cut of meat 181 is desirably cooked rare.

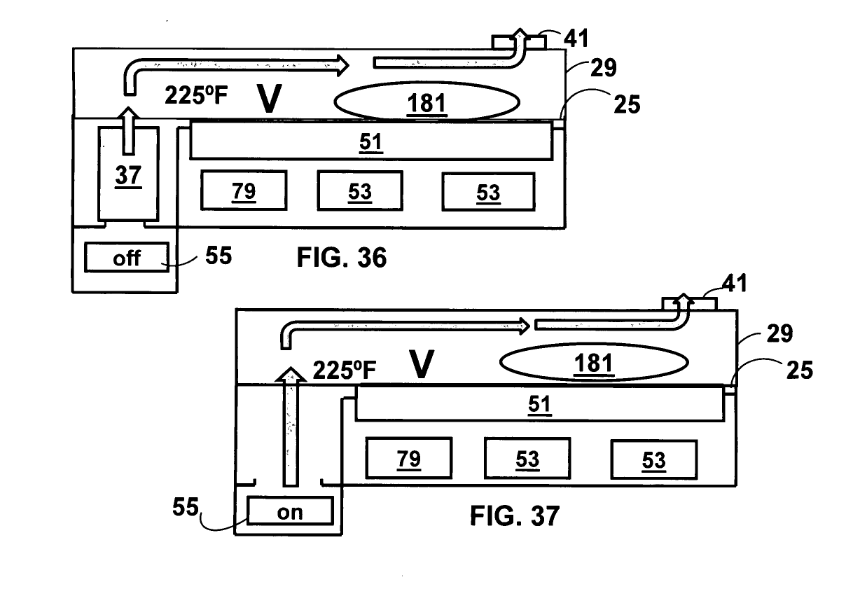

FIG. 36 shows a schematic view taken from the front perspective of a device according to some embodiments of the disclosure being operated in one desirable mode. Burn box 37 is present in first chamber 21 containing burning wood and/or charcoal and partition pan 51 is present in its functional position, and a cut of meat 181 is disposed on food cooking surface 25. The heat and combustion product gases pass in the direction shown by the arrowed line, and in this mode cooking temperatures present in volume V above cooking surface 25 and within cover 29 are fairly constant, with the amount of heat entering volume V being substantially equal to the amount of heat exiting adjustable vent port 41.

FIG. 37 shows a schematic view taken from the front perspective of a device according to some embodiments of the disclosure as was described in relation to FIG. 36, however with the burn box 37 not being present, and with combustion occurring at burner 55, providing heat and combustion product gases which travel in the direction indicated by the arrowed line. The mode of operation enabled by this structure is useful for low temperature cooking, in the range of between about 190 degrees Fahrenheit and about 250 degrees Fahrenheit.

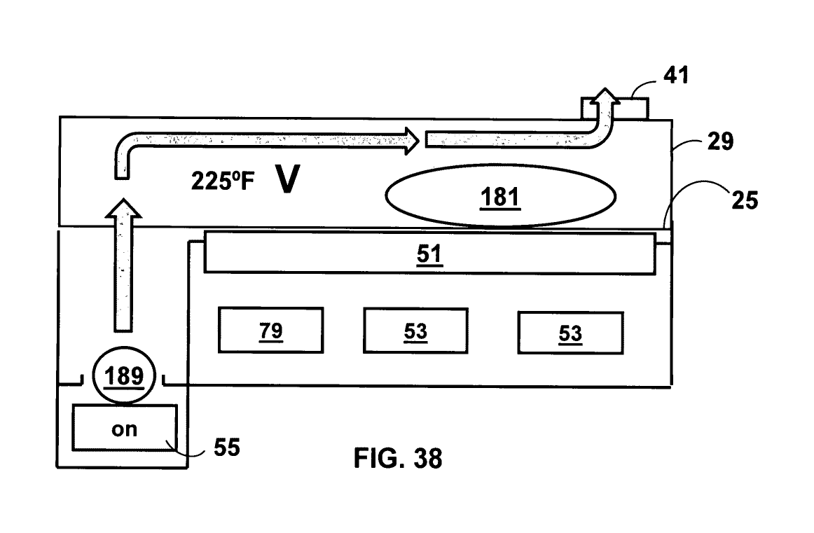

FIG. 38 shows a schematic view taken from the front perspective of a device according to some embodiments of the disclosure, in an alternate operating mode. In this alternate operating mode, partition pan 51 is disposed in its functional position, burn box 37 is not present, and ignited burner 55 is used as the sole heat source. A metal can 189 or other suitable container that has been at least partially filled with wood and/or charcoal is placed directly atop burner 55. This arrangement provides for emission of smoke (including smoke made by singeing of wood, charcoal, etc.) while simultaneously providing for burner 55 to heat volume V to barbeque temperatures or roasting temperatures, as desired. Operation in this mode is very simple and provides excellent tasting meats.

Although it has been set forth in the foregoing that in some embodiments first chamber 21 and second chamber 23 each have four walls, an open top end portion and bottom end portions at which generally at least one gas-fired burner is present, it is also within this disclosure to provide such chambers to comprise any number of walls three or greater, also including hemi-spherical, ovoid, and other shaped single-walled chambers that comprise a single surface, and multi-walled chambers. Modification of the shape of the cooking surface 25 and partition pan 51 are employed in these embodiments, configured to reside atop a rim analogous to rim 81 present in these embodiments of this disclosure and appropriately shaped to provide the same or substantially the same functionality as herein described. In some embodiments, safety exhaust port 43 is present at a lesser distance from the ground upon which a device as provided herein rests than the below-grid exhaust 45 is located. Stated another way, below-grid exhaust 45 is in some embodiments present on a device provided herein at a point higher off the surface on which a device as provided herein resides than is safety exhaust port 43, and the difference between the distances of each of these exhausts from the ground is any distance between about 1 centimeter and about 50 centimeters, including all distances and ranges of distances therebetween, with a distance of about 30 centimeters being employed in some embodiments. Moreover, in some embodiments the difference between the distances that the adjustable vent port 35 and said safety exhaust port 43 are present with respect to a surface on which a device as provided herein resides is any distance between about 1 centimeter and about 30 centimeters, including all distances and ranges of distances therebetween, with a distance of about 7 centimeters being employed in some embodiments.

Devices provided herein have been shown and described as comprising a compressed gas fuel vessel and conduits attached between the fuel vessel and the burners sufficient to convey fuel from the vessel to the burners, with gas flow control valves present along the path of the conduits. In some embodiments, at least one of the control valves present are equipped with a thermopile, which valve/thermopile combination is capable of acting as a safety sentry, turning off gas flow in the event the loss of a flame is detected, as such devices are known in the art. In some embodiments safety features are provided to prevent inadvertent ignition of underlying gas burners when the burners are blocked by installation of the partition pan or burn box 37. In some embodiments the safety features comprise valves that prevent gas flow to burners when the burners are covered. In some embodiments, if the safety features are tampered with or become defective, the inherent passive design of a device as provided herein provides for the burners to be in fluid communication with outside vent in all modes.

Consideration must be given to the fact that although the subject matter contained in this disclosure has been concerned in some instances with respect to particular configurations, modifications and alterations of a device described herein to provide substantially the same function are clear to persons of ordinary skill in this art after reading and understanding the teachings of this specification, drawings, and the claims appended hereto. The present disclosure includes subject matter defined by any combination(s) of any one or more of the features provided with reference to any one or more than one embodiments of this disclosure with any one or more than one features provided in reference to other embodiments described, to provide a unit having utility and function taught herein. These combinations include the incorporation of the features and/or limitations of any dependent claim presented, singly or in combination with features and/or limitations of any one or more than one of the other dependent claims presented, with features and/or limitations of any one or more than one of the independent claims presented, with the remaining dependent claims presented in their original text being read and applied to any independent claims so modified. These combinations also include combination of the features and/or limitations of any one or more than one of the independent claims presented with features and/or limitations of any one or more than one other independent claims presented to arrive at a modified independent claim, with the remaining dependent claims presented in their original text or as modified per the foregoing, being read and applied to any independent claim so modified.

1. A device useful for cooking and smoking foodstuffs comprising, in combination:
a) a framework;
b) a first chamber comprising a top portion, a bottom portion, and a wall, further comprising a first gas burner present substantially at said bottom portion;
c) a second chamber comprising a top portion, a bottom portion, and a wall, further comprising at least one gas burner present substantially at said bottom portion of said second chamber;
d) a cooking surface support structure present substantially at the top portion of said second chamber;
e) a cover having a wall and configured to simultaneously cover and at least substantially separate the top portions of each of said first chamber and said second chamber from the ambient atmosphere when in a closed position, said cover including a vent having an adjustable aperture disposed through its wall;
f) a safety exhaust port disposed through a wall present in said first chamber; and
g) a below-grid exhaust port disposed through a wall present in said second chamber.

2. A device according to claim 1 further comprising:
h) an adjustable vent port disposed through a wall present in said first chamber.

3. A device according to claim 1 wherein said cooking surface support structure is configured to sealingly engage a partition pan placed upon said support structure, sufficiently to provide a barrier between said cooking surface and said below-grid exhaust port.

4. A device according to claim 1 said first chamber further comprising a floor having an opening present through its surface, said floor being present above said first gas burner with respect to said open top portion of said first chamber, wherein said floor is configured to sealingly engage a surface present on a burn box that is caused to be disposed in said first chamber.

5. A device according to claim 4 wherein said floor is configured to receive a cover that that sealingly engages said opening, effectively closing said opening.

6. A device according to claim 1 said open top portion of said first chamber being substantially at the same level as said open top portion of said second chamber.

7. A device according to claim 1 wherein said cover is dual-walled construction.

8. A device according to claim 1 wherein each layer of said dual-walled construction is comprised of metal.

9. A device according to claim 1 wherein said framework is wheeled.

10. A device according to claim 1 wherein said cover is hingeably attached to said device.

11. A device according to claim 1 wherein said first chamber and said second chamber share at least one wall in common with one another.

12. A device according to claim 1 wherein the top portion of said second chamber is configured to receive a removable food cooking surface.

13. A device according to claim 1 said top portion of said second chamber is configured to receive a partition pan.

14. A device according to claim 1 wherein each of said first chamber and said second chamber comprise four walls.

15. A device according to claim 1 wherein at least one gas burner present substantially at said bottom portion of said second chamber is a radiant burner.

16. A device according to claim 1 wherein at least a portion of the opening of said below-grid exhaust port is present on said device at a location that is at a greater elevation from a surface on which said device resides than said safety exhaust port.

17. A device according to claim 16 wherein the difference between the distances that said below-grid exhaust port and said safety exhaust port reside with respect to a surface on which a device as provided herein resides is any distance between about 1 centimeter and about 50 centimeters.

18. A device according to claim 1 wherein the difference between the distances that said adjustable vent port and said safety exhaust port reside with respect to a surface on which a device as provided herein resides is any distance between about 1 centimeter and about 30 centimeters.

19. A device according to claim 1 further comprising:
h) a fire box having an inner volume that is in fluid communication with said first chamber via an opening disposed between the interior of said fire box and said first chamber, said fire box being attached to said device.

20. A device according to claim 19 wherein said fire box further comprises an adjustable vent.

21. A device according to claim 1 wherein said cooking surface support structure is disposed substantially at said top portion of said second chamber.

22. A device according to claim 1 further comprising a fuel vessel and conduits attached between said fuel vessel and said burners sufficient to convey fuel from said vessel to said burners, with gas flow control valves present along the path of said conduits.

23. A device according to claim 22 wherein said control valves include a thermopile capable of causing cessation of gas flow in the event that the flame present on a burner becomes extinguished.
